(19) United States
(12) Patent Application Publication
(10) Pub. No.: US 2004/0254089 A1
(43) Pub. Date: Dec. 16, 2004

(54) Use of compounds in products for laundry applications

(76) Inventors: Dominique Charmot, Campbell, CA (US); Manikandan Jayaraman, San Francisco, CA (US); Han Ting Chang, Livermore, CA (US); Paul Mansky, San Francisco, CA (US); Wilfried Blokzijl, Wirral (GB); Christopher Clarkson Jones, Wirral (GB)

Correspondence Address: UNILEVER, PATENT DEPARTMENT, 45 RIVER ROAD, EDGEWATER, NJ, 07020, US

(21) Appl. No.: 10/484,291

(22) PCT Filed: Jul. 10, 2002
(86) PCT No.: PCT/EP02/07685

Related U.S. Application Data
(60) Provisional application No. 60/306,738, filed on Jul. 20, 2001.

(30) Foreign Application Priority Data
Aug. 7, 2001 (GB) 0119258.2

(51) Int. Cl. C11D 3/37

(52) U.S. Cl. 510/475

(57) ABSTRACT

Laundry treatment products comprise a graft polymer benefit agent and at least one additional laundry cleaning ingredient. The graft polymer benefit agent preferably provides soil release or fabric care benefits. The graft polymer benefit agent comprises a polysaccharide backbone and a plurality of graft chains extending from the backbone, each graft chain having a degree of polymerisation between 5 and 250. The graft polymer is substantially free of cross-linking and has a degree of substitution of grafts across a bulk sample in the range of from 0.02 to 1.0. The graft polysaccharide copolymers may be prepared using living-type free radical polymerisation techniques which provide control over the degree of substitution, the graft/co-block composition and structure.

### FIELD OF INVENTION

The present invention relates to compounds (including oligomers and polymers) which are useful in laundry treatment products, e.g. for incorporation in products for dosing in the wash and/or rinse. They are intended for, but not limited to, soil release, fabric care and/or other laundry cleaning benefits in such products.

### BACKGROUND OF THE INVENTION

The compounds utilised by the present invention have been found, dependent upon the structure of the compound in question, to deliver a soil release, fabric care and/or other laundry cleaning benefit.

The deposition of a benefit agent onto a substrate, such as a fabric, is well known in the art. In laundry applications typical “benefit agents” include fabric softeners and conditioners, soil release polymers, sunscreens; and the like. Deposition of a benefit agent is used, for example, in fabric treatment processes such as fabric softening to impart desirable properties to the fabric substrate.

Conventionally, the deposition of the benefit agent has had to rely upon the attractive forces between the oppositely charged substrate and the benefit agent. Typically this requires the addition of benefit agents during the rinsing step of a treatment process so as to avoid adverse effects from other charged chemical species present in the treatment compositions. For example, cationic fabric conditioners are incompatible with anionic surfactants in laundry washing compositions.

Such adverse charge considerations can place severe limitations upon the inclusion of benefit agents in compositions where an active component thereof is of an opposite charge to that of the benefit agent. For example, cotton is negatively charged and thus requires a positively charged benefit agent in order for the benefit agent to be substantive to the cotton, i.e. to have an affinity for the cotton so as to absorb onto it. Often the substantivity of the benefit agent is reduced and/or the deposition rate of the material is reduced because of the presence of incompatible charged species in the compositions. However, in recent times, it has been proposed to deliver a benefit agent in a form whereby it is substituted onto another chemical moiety which increases its affinity for the substrate in question.

The compounds used by the present invention for soil-release and/or other benefits are substituted polysaccharide structures, especially substituted cellulosic structures.

Recently, substituted cellulosic oligomers and polymers have been proposed as ingredients in laundry products for providing a variety of different benefits such as fabric rebuild, as disclosed in WO-A-98/29528, WO-A-99/14245, WO-A-00/18861, WO-A-/18862, WO-A-00/40684 and WO-A-00/40685.

U.S. Pat. No. 4,235,735 discloses cellulose acetates with a defined degree of substitution as anti-redeposition agents in laundry products.

Cellulosic esters are also known for use in non-laundry applications, as described in WO-A-91/16359 and GB-A-1 041 020.

The grafting of synthetic polymers onto a cellulosic backbone has been the subject of research activities for a long time with the object of producing a polymer that has the beneficial properties of both cellulose and the synthetic polymers. Enormous research and development efforts have occurred over the last 40 years, but no polymer or process has yet been discovered which has proceeded to commercialisation.

The grafting of polymers on a cellulosic backbone proceeds through radical polymerisation wherein an ethylenic monomer is contacted with a soluble or insoluble cellulosic material together with a free radical initiator. The radical thus formed reacts on the cellulosic backbone (usually by proton abstraction), creates radicals on the cellulosic chain, which subsequently react with monomers to form graft chains on the cellulosic backbone. Related techniques use other sources of radical such as high energy irradiation or oxidising agents such as Cerium salt or redox systems such as thiocarbonate-potassium bromate. These methods are well known, see, e.g., McDonald, et al. Prog. Polym. Sci. 1984, 10, 1; Hebeish et al, “The Chemistry and Technology of cellulosic copolymers”, (Springer Verlag, 1981); Samal et al. J. Macromol. Sci-Rev.Macromol. Chem. 1986, 26, 81; Waly et al, Polymers & polymer composites 4,1,53,1996; and D. Klenn et al, Comprehensive Cellulose Chemistry, vol. 2 “Functionalization of Cellulose” pp, 17-31 (Wiley-VCH, Weinheim, 1998); each of which is incorporated herein by reference.

Another strategy involves functionalising the cellulose backbone with a reactive double bond and polymerising in the presence of monomers under conventional free radical polymerisation conditions, see, e.g., U.S. Pat. No. 4,758,645. Alternatively, a free radical initiator is covalently linked to the polysaccharide backbone to generate a radical from the backbone to initiate polymerisation and form graft copolymers (see, e.g., Bojanic V, J, Appl. Polym. Sci., 60,1719-1725, 1996 and Zheng et al, ibid, 66, 307-317, 1997), For example, in U.S. Pat. No. 4,206,108, a thiol is covalently bound to a polymeric backbone with pendent hydroxy groups via a urethane linkage; this polymer containing mercapto group is then reacted with ethylenically unsaturated monomers to form the graft copolymer.

Unfortunately, none of these techniques lead to a well-defined material with a controlled macrostructure, and microstructure. For instance, none of these techniques leads to a good control of both the number of graft chains per cellulose backbone molecule and molecular weight of the graft chains. Moreover, side reactions are difficult, if not impossible, to avoid, including the formation of un-grafted polymer, graft chain degradation and/or crosslinking of the grafted chains.

In an attempt to solve these problems, pre-formed chains have been chemically grafted onto cellulosic polymers. For instance, in U.S. Pat. No. 4,891,404, polystyrene chains were grown in an anionic polymerization and capped with, e.g., CO₂. These grafts were then attached to mesylated or tosylated cellulose triacetate by nucleophilic displacement. This method is difficult to commercialise because of the stringent conditions required by the method. Moreover, the set of monomers that can be used in this method is restricted to non-polar olefins, thus precluding any application in water media.

Block copolymers based on cellulose esters have been reported. See, e.g., Oliveira et al, Polymer, 35, 9, 1994; Feger et al, Polymer Bulletin, 3,407, 1980; Feger et al, Ibid, 6, 321, 1982; U.S. Pat. No. 3,386,932; Steinmann, Polym. Preprint, Am. Chem. Soc. Div. Polym. Chem. 1970, 11, 285; Kim et al, J. Polym. Sci. Polym, Lett. Ed., 1973,11, 731; and Kim et al. J. Macromol. Sci., Chem (A) 1976,10, 671, each of which is incorporated herein by reference. A major problem with these references is the generation of considerable chain branching, grafting or crosslinking. Mezger et al, Angew. Makromol Chem., 116,13,1983 prepared oligomeric, monohydroxy-terminated cellulose coupled with 4,-4′-diphenyldisocyanate, which was then used as a UV-macro-photo-initiator to prepare triblock copolymers. This reaction is known as the iniferter technique and uses UV initiation, which limits its applicability to certain processing methods. Furthermore, it is typically applicable to styrenic and methacrylic monomers. Other monomers, such as acrylics, vinyl acetate, acrylamide type monomers, which are in widespread use in waterborne systems, might require another technique.

So-called “living” radical polymerisation techniques are known which can give better defined polymers in terms of molecular structure. Three approaches to preparation of controlled polymers in a “living” radical process have been described (Greszta et al, Macromolecules, 27, 638 (1994)). The first approach involves the situation where growing radicals react reversibly with scavenging radicals to form covalent species. The second approach involves the situation where growing radicals react reversibly with covalent species to produce persistent radicals. The third approach involves the situation where growing radicals participate in a degenerative transfer reaction which regenerates the same type of radicals. However, none of these techniques have been successfully applied to polysaccharide substrates.

As mentioned above, it has previously been recognised in the art that cellulose based materials adhere to cotton fibres. For example, WO 00/18861 and WO 00/18862 disclose cellulosic compounds having a benefit agent attached, so that the benefit agent will be attached to the fibre. See also WO 99/14925. However, the ability of polysaccharide, especially cellulose, based materials to adhere has not been fully investigated, and a need exists to find polysaccharide based materials that are of commercial significance.

### DEFINITION OF THE INVENTION

According to a first aspect of the invention, there is provided a laundry cleaning composition comprising a graft polymer benefit agent and at least one additional laundry cleaning ingredient, the graft polymer benefit agent comprising a polysaccharide backbone and a plurality of graft chains extending from said backbone, each of said plurality of graft chains having a degree of polymerisation between 5 and 250, preferably between 5 and 50 or between 25 and 250, wherein said graft polymer is substantially free of cross-linking and has a degree of substitution of grafts across a bulk sample in the range of from 0.02 to 1.0, preferably from 0.02 to 0.2 or from 0.1 to 1.0.

In the context of this specification, the term “cleaning” means “washing and/or rinsing”.

A second aspect of the invention provides a method of delivering one or more laundry benefits in the cleaning of a textile fabric, the method comprising contacting the fabric with a graft polymer as defined above, preferably in the form of a laundry cleaning composition a method of delivering one or more laundry benefits in the washing of a textile fabric, the method comprising contacting the fabric with a polymer as defined above, preferably in the form of a laundry cleaning composition comprising said polymer, and most preferably in the form of an aqueous dispersion or solution of said composition. The method may also include the further step of cleaning the fabric subsequently after wear or use.

The second aspect of the invention may also be expressed as use of a compound for delivering a benefit to a laundry item, the compound being a graft polymer comprising a polysaccharide backbone and a plurality of graft chains extending from said backbone, each of said plurality of graft chains having a degree of polymerisation between 5 and 250, preferably between 5 and 50 or between 25 and 250, wherein said graft polymer is substantially free of cross-linking and has a degree of substitution of grafts across a bulk sample in the range of from 6.02 to 1.0, preferably from 0.02 to 0.2 or from 0.1 to 1.0.

The second aspect of the invention may further be expressed as use of a compound in the manufacture of a laundry cleaning composition, the compound being a graft polymer comprising a polysaccharide backbone and a plurality of graft chains extending from said backbone, each of said plurality of graft chains having a degree of polymerisation between 5 and 250, wherein said graft polymer is substantially free of cross-linking and has a degree of substitution of grafts across a bulk sample in the range of from 0.02 to 1.0.

When the benefit is soil release, the second aspect of the invention may be expressed as a method of promoting soil release in the washing of a textile fabric, the method comprising contacting the fabric with a soil release polymer as defined above and subsequently, after wear or use, washing the fabric.

This aspect may also be expressed as use of a compound for promoting soil release during the washing of a textile fabric, the compound being a graft polymer as defined above.

In addition, this aspect may be expressed as use of a soil release polymer in the manufacture of a laundry cleaning composition, the soil release polymer being a graft polymer as defined above.

A third aspect of the invention provides a graft polymer as defined above for deposition onto a fabric during a laundry cleaning process.

The third aspect of the invention may also be expressed as a method of depositing a benefit agent onto a fabric, the method comprising applying a graft polymer or a composition as defined above to the fabric.

The polysaccharide grafted and copolymeric materials utilised in this invention with well defined macromolecular features find utility in a wide field of applications. In particular, due to their segmented structures, these polymers have applicability as compatibilisers between naturally occurring bio-polymers such as starch or cellulose with synthetic thermoplastic resins, so-called biodegradable bio-plastics.

Furthermore, the polymers utilised in this invention may be water soluble, or at least water-dispersible (e.g., water swellable). In some of these embodiments, the cellulosic moiety is known to adsorb to cellulosic surfaces, such as cotton or papers which then alter the surface or interface of cotton/paper and bring new benefits to the fibre or surface.

### BRIEF DESCRIPTION OF THE DRAWINGS

FIG. 1 is a schematic drawing of the processes of this invention for preparation of grafted polysaccharide materials and copolymeric materials for use in the present invention.

FIG. 2 is a block diagram showing the various routes for employing hydrolysis or saponification in the preparation of cellulosic grafted or copolymeric materials.

FIG. 3 is a graft of a calibration plot in connection with Example 2.

FIG. 4 is a graft showing the relationship between graft length in cellulosic graft polymer to adsorbancy onto cotton fibers.

FIGS. 5A and 5B are each graphs showing selected experimental results from Example 3, with FIG. 5A showing the amount of cellulosic graft THMMA polymer with a degree of substitution of 0.023 deposited onto cotton fibres after a treatment process and FIG. 5B showing results of a similar experiment showing the amount of cellulosic graft THMMA polymer with a degree of substitution of 0.18 deposited onto cotton fibres after a treatment process.

FIG. 6 is a plot of grafts per chain versus graft degree of polymerisation from Example 3.

### DETAILED DESCRIPTION OF THE INVENTION

Benefits

The compounds which form the basis of the present invention provide one or more of the following benefits, according to the compound in question: soil release, anti-redeposition, soil repellancy, colour care especially anti-dye transfer and dye fixation, anti-wrinkling, ease of ironing, fabric rebuild, anti-fibre damage, anti-pilling, anti-colour fading, dimensional stability, good drape and body, waterproofing, fabric softening and/or conditioning, fungicidal properties and insect repellancy.

Definitions

The following definitions pertain to chemical structures, molecular segments and substituents:

As used herein, the term “compound” includes materials of any molecular weight, be they simple structures which are generally considered to be monomers, dimers, trimers, higher oligomers as well as polymers.

The phrase “having the structure” is not intended to be limiting and is used in the same. way that the term “comprising” is commonly used. The term “independently selected from the group consisting of” is used herein to indicate that the recited elements, e.g., R groups or the like, can be identical or different.

“Optional” or “optionally” means that the subsequently described event or occurrence may or may not occur, and that the description includes instances where said event or circumstance occurs and instances where it does not. For example, the phrase “optionally substituted hydrocarbyl” means that a hydrocarbyl moiety may or may not be substituted and that the description includes both unsubstituted hydrocarbyl and hydrocarbyl where there is substitution.

The term “alkyl” as used herein refers to a branched or unbranched saturated hydrocarbon group typically although not necessarily containing 1 to about 24 carbon atoms, such as methyl, ethyl, n-propyl, isopropyl, n-butyl, isobutyl, t-butyl, octyl, decyl, and the like, as well as cycloalkyl groups such as cyclopentyl, cyclohexyl and the like. Generally, although again not necessarily, alkyl groups herein contain 1 to about 12 carbon atoms. More preferably, an alkyl group, sometimes termed a “lower alkyl” group, contains one to six carbon atoms, preferably one to four carbon atoms. “Substituted alkyl” refers to alkyl substituted with one or more substituent groups, and the terms “heteroatom-containing alkyl” and “heteroalkyl” refer to alkyl in which at least one carbon atom is replaced with a heteroatom.

The term “alkenyl” as used herein refers to a branched or unbranched hydrocarbon group typically although not necessarily containing 2 to about 24 carbon atoms and at least one double bond, such as ethenyl, n-propenyl, isopropenyl, n-butenyl, isobutenyl, octenyl, decenyl, and the like. Generally, although again not necessarily, alkenyl groups herein contain 2 to about 12 carbon atoms. More preferably, an alkenyl group, sometimes termed a “lower alkenyl” group, contains two to six carbon atoms, preferably two to four carbon atoms. “Substituted alkenyl” refers to alkenyl substituted with one or more substituent groups, and the terms “heteroatom-containing alkenyl” and “heteroalkenyl” refer to alkenyl in which at least one carbon atom is replaced with a heteroatom.

The term “alkynyl” as used herein refers to a branched or unbranched hydrocarbon group typically although not necessarily containing 2 to about 24 carbon atoms and at least one triple bond, such as ethynyl, n-propynyl, isopropynyl, n-butynyl, isobutynyl, octynyl, decynyl, and the like. Generally, although again not necessarily, alkynyl groups herein contain 2 to about 12 carbon atoms. More preferably, an alkynyl group, sometimes termed a “lower alkynyl” group, contains two to six carbon atoms, preferably three or four carbon atoms. “Substituted alkynyl” refers to alkynyl substituted with one or more substituent groups, and the terms “heteroatom-containing alkynyl” and “heteroalkynyl” refer to alkynyl in which at least one carbon atom is replaced with a heteroatom.

The term “alkoxy” as used herein intends an alkyl group bound through a single, terminal ether linkage; that is, an “alkoxy” group may be represented as —O-alkyl where alkyl is as defined above. More preferably, an alkoxy group, sometimes termed a “lower alkoxy” group, contains one to six, more preferably one to four, carbon atoms. The term “aryloxy” is used in a similar fashion, with aryl as defined below.

Similarly, the term “alkyl thio” as used herein intends an alkyl group bound through a single, terminal thioether linkage; that is, an “alkyl thio” group may be represented as —S-alkyl where alkyl is as defined above. More preferably, an alkylthio group, sometimes termed a “lower alkyl thio” group, contains one to six, more preferably one to four, carbon atoms.

The term “allenyl” is used herein in the conventional sense to refer to a molecular segment having the structure —CH═C═CH₂. An “allenyl” group may be unsubstituted or substituted with one or more non-hydrogen substituents.

The term “aryl” as used herein, and unless otherwise specified refers to an aromatic substituent containing a single aromatic ring or multiple aromatic rings that are fused together, linked covalently, or linked to a common group such as a methylene or ethylene moiety. The common linking group may also be a carbonyl as in benzophenone, an oxygen atom as in diphenylether, or a nitrogen atom as in diphenylamine, Preferred aryl groups contain one aromatic ring or two fused or linked aromatic rings, e.g., phenyl, naphthyl, biphenyl, diphenylether, diphenylamine, benzophenone, and the like. In particular embodiments, aryl substituents have 1 to about 200 carbon atoms, typically 1 to about 50 carbon atoms, and preferably 1 to about 20 carbon atoms. More preferably, aryl groups contain from 6 to 18, preferably 6 to 16 and especially 6 to 14, carbon atoms. Phenyl and naphthyl, particularly phenyl, groups are especially preferred. “Substituted aryl” refers to an aryl moiety substituted with one or more substituent groups, (e.g., tolyl, mesityl and perfluorophenyl) and the terms “heteroatom-containing aryl” and “heteroaryl” refer to aryl in which at least one carbon atom is replaced with a heteroatom.

The term “aralkyl” refers to an alkyl group with an aryl substituent, and the term “aralkylene” refers to an alkylene group with an aryl substituent; the term “alkaryl” refers to an aryl group that has an alkyl substituent, and the term “alkarylene” refers to an arylene group with an alkyl substituent. Preferred aralkyl groups contain from 7 to 16, especially 7 to 10, carbon atoms, a particularly preferred aralkyl group being a benzyl group.

The terms “halo” and “halogen” are used in the conventional sense to refer to a chloro, bromo, fluoro or iodo substituent. The terms “haloalkyl,” “haloalkenyl” or “haloalkynyl” (or “halogenated alkyl”, “halogenated alkenyl,” or “halogenated alkynyl”) refer to an alkyl, alkenyl or alkynyl group, respectively; in which at least one of the hydrogen atoms in the group has been replaced with a halogen atom.

The term “heteroatom-containing” as in a “heteroatom-containing hydrocarbyl group” refers to a molecule or molecular fragment in which one or more carbon atoms is replaced with an atom other than carbon, e.g., nitrogen, oxygen, sulfur, phosphorus or silicon. Similarly, the term “heteroalkyl” refers to an alkyl substituent that is heteroatom-containing, the term “heterocyclic” refers to a cyclic substituent that is heteroatom-containing, the term “heteroaryl” refers to an aryl substituent that is heteroatom-containing, and the like. When the term “heteroatom-containing” appears prior to a list of possible heteroatom-containing groups, it is intended that the term apply to every member of that group. That is, the phrase “heteroatom-containing alkyl, alkenyl and alkynyl” is to be interpreted as “heteroatom-containing alkyl, heteroatom-containing alkenyl and heteroatom-containing alkynyl.” Preferably, a heterocyclic group is 3- to 18-membered, particularly a 3- to 14-membered, and especially a 5- to 10-membered ring system containing at least one heteroatom.

“Hydrocarbyl” refers to univalent hydrocarbyl radicals containing 1 to about 30 carbon atoms, preferably 1 to about 24 carbon atoms, most preferably 1 to about 12 carbon atoms, including branched or unbranched, saturated or unsaturated species, such as alkyl groups, alkenyl groups, aryl groups, and the like. The term “lower hydrocarbyl” intends a hydrocarbyl group of one to six carbon atoms, preferably one to four carbon atoms. “Substituted hydrocarbyl” refers to hydrocarbyl substituted with one or more substituent groups, and the term “heteroatom-containing hydrocarbyl” and “heterohydrocarbyl” refer to hydrocarbyl in which at least one carbon atom is replaced with a heteroatom.

By “substituted” as in “substituted hydrocarbyl,” “substituted aryl,” “substituted alkyl,” “substituted alkenyl” and the like, as alluded to in some of the aforementioned definitions, is meant that in the hydrocarbyl, hydrocarbylene, alkyl, alkenyl or other moiety, at least one hydrogen atom bound to a carbon atom is replaced with one or more substituents that are functional groups such as hydroxyl, alkoxy, thio, phosphino, amino, halo, silyl, and the like. When the term “substituted” appears prior to a list of possible substituted groups, it is intended that the term apply to every member of that group. That is, the phrase “substituted alkyl, alkenyl and alkynyl” is to be interpreted as “substituted alkyl, * substituted alkenyl and substituted alkynyl”. Similarly, “optionally substituted alkyl, alkenyl and alkynyl” is to be interpreted as “optionally substituted alkyl, optionally substituted alkenyl and optionally substituted alkynyl.”

When any of the foregoing substituents are designated as being optionally substituted, the substituent groups which are optionally present may be any one or more of those customarily employed in the development of laundry treatment compounds and/or the modification of such compounds to influence their structure/activity, stability, or other property. Specific examples of such substituents include, for example, halogen atoms, nitro, cyano, hydroxyl, cycloalkyl, alkyl, haloalkyl, cycloalkyloxy, alkoxy, haloalkoxy, amino, alkylamino, dialkylamino, formyl, alkoxycarbonyl, carboxyl, alkanoyl, alkylthio, alkylsulphinyl, alkylsulphonyl, alkylsulphonato, carbamoyl and alkylamido groups. When any of the foregoing substituents represents or contains an alkyl substituent group, this may be linear or branched and may contain up to 12, preferably up to 6, and especially up to 4, carbon atoms. A cycloalkyl group may contain from 3 to 8, preferably from 3 to 6, carbon atoms. A halogen atom may be a fluorine, chlorine, bromine or iodine atom and any group which contains a halo moiety, such as a haloalkyl group, may thus contain any one or more of these halogen atoms.

As used herein the term “silyl” refers to the —SiZ¹Z²Z³ radical, where each of Z¹, Z², and Z³ is independently selected from the group consisting of hydrido and optionally substituted alkyl, alkenyl, alkynyl, aryl, aralkyl, alkaryl, heterocyclic, alkoxy, aryloxy and amino.

As used herein, the term “phosphino” refers to the group —PZ¹Z², where each of Z¹ and Z² is independently selected from the group consisting of hydrido and optionally substituted alkyl, alkenyl, alkynyl, aryl, aralkyl, alkaryl, heterocyclic and amino.

The term “amino” is used herein to refer to the group —NZ¹Z², where each of Z¹ and Z² is independently selected from the group consisting of hydrido and optionally substituted alkyl, alkenyl, alkynyl, aryl, aralkyl, alkaryl and heterocyclic.

The term “thio” is used herein to refer to the group —SZ¹, where Z¹ is selected from the group consisting of hydrido and optionally substituted alkyl, alkenyl, alkynyl, aryl, aralkyl, alkaryl and heterocyclic.

As used herein all reference to the elements and groups of the Periodic Table of the Elements is to the version of the table published by the Handbook of Chemistry and Physics, CRC Press, 1995, which sets forth the new IUPAC system for numbering groups.

The term “soil release polymer” is used in the art to cover polymeric materials which assist release of soil from fabrics, e.g. cotton or polyester based fabrics. For example, it is used in relation to polymers which assist release of soil direct from fibres. It is also used to refer to polymers which modify the fibres so that dirt adheres to the polymer-modified fibres rather than to the fibre material itself. Then, when the fabric is washed the next time, the dirt is more easily removed than if it was adhering the fibres. Although not wishing to be bound by any particular theory or explanation, the inventors believe that those compounds utilised in the present invention which deliver a soil release benefit, probably exert their effect mainly by the latter mechanism.

As those of skill in the art of polysaccharide, especially cellulosic, polymers recognise, the term “degree of substitution” (or DS) refers to substitution of the functional groups on the repeating sugar unit. In the case of cellulosic polymers, DS refers to substitution of the three hydroxyl groups on the repeating anhydroglucose unit. Thus, for cellulose polymers, the maximum degree of substitution is 3. DS values do not generally relate to the uniformity of substitution of chemical groups along the polysaccharide molecule and are not related to the molecular weight of the polysaccharide backbone. The average degree of substitution groups is preferably from 0.1 to 3 (e.g. from 0.3 to 3), more preferably from 0.1 to 1 (e.g. from 0.3 to 1).

The Polysaccharide Before Substitution

As used herein, the term “polysaccharides” includes natural polysaccharides, synthetic polysaccharides, polysaccharide derivatives and modified polysaccharides. Suitable polysaccharides for use in the treating compositions of the present invention include, but are not limited to, gums, arabinans, galactans, seeds and mixtures thereof as well as cellulose and derivatives thereof.

Suitable polysaccharides that are useful in the present invention include polysaccharides with a degree of polymerisation (DP) over 40, preferably from about 50 to about 100,000, more preferably from about 500 to about 50,000. Constituent saccharides preferably include, but are not limited to, one or more of the following saccharides: isomaltose, isomaltotriose, isomaltotetraose, isomaltooligosaccharide, fructooligosaccharide, levooligosaccharides, galactooligosaccharide, xylooligosaccharide, gentiooligosaccharides, disaccharides, glucose, fructose, galactose, xylose, mannose, sorbose, arabinose, rhamnose, fucose, maltose, sucrose, lactose, maltulose, ribose, lyxose, allose, altrose, gulose, idose, talose, trehalose, nigerose, kojibiose, lactulose, oligosaccharides, maltooligosaccharides, trisaccharides, tetrasaccharides, pentasaccharides, hexasaccharides, oligosaccharides from partial hydrolysates of natural polysaccharide sources and mixtures thereof.

The polysaccharides can be extracted from plants, produced by organisms, such as bacteria, fungi, prokaryotes, eukaryotes, extracted from animal and/or humans. For example, xanthan gum can be produced by Xanthomonas campestris, gellan by Sphingomonas paucimobilis, xyloglucan can be extracted from tamarind seed.

The polysaccharides can be linear, or branched in a variety of ways, such as 1-2, 1-3, 1-4, 1-6, 2-3 and mixtures thereof. Many naturally occurring polysaccharides have at least some degree of branching, or at any rate, at least some saccharide rings are in the form of pendant side groups on a main polysaccharide backbone.

It is desirable that the polysaccharides of the present invention have a molecular weight in the range of from about 10,000 to about 10,000,000, more preferably from about 50,000 to about 1,000,000, most preferably from about 50,000 to about 500,000.

Preferably, the polysaccharide is selected from the group consisting of: tamarind gum (preferably consisting of xyloglucan polymers), guar gum, locust bean gum (preferably consisting of galactomannan polymers), and other industrial gums and polymers, which include, but are not limited to, Tara, Fenugreek, Aloe, Chia, Flaxseed, Psyllium seed, quince seed, xanthan, gellan, welan, rhamsan, dextran, curdlan, pullulan, scleroglucan, schizophyllan, chitin, hydroxyalkyl cellulose, arabinan (preferably from sugar beets), de-branched arabinan (preferably from sugar beets), arabinoxylan (preferably from rye and wheat flour), galactan (preferably from lupin and potatoes), pectic galactan (preferably from potatoes), galactomannan (preferably from carob, and including both low and high viscosities), glucomannan, lichenan (preferably from icelandic moss), mannan (preferably from ivory nuts), pachyman, rhamnogalacturonan, acacia gum, agar, alginates, carrageenan, chitosan, clavan, hyaluronic acid, heparin, inulin, cellodextrins, cellulose, cellulose derivatives and mixtures thereof. These polysaccharides can also be treated (preferably enzymatically) so that the best fractions of the polysaccharides are isolated.

Polysaccharides can be used which have an α- or β-linked backbone. However, more preferred polysaccharides have a β-linked backbone, preferably a β-1,4-linked backbone. It is preferred that the β-1,4-linked polysaccharide is cellulose, a cellulose derivative, particularly cellulose sulphate, cellulose acetate, sulphoethylcellulose, cyanoethylcellulose, methyl cellulose, ethyl cellulose, carboxymethylcellulose, hydroxyethylcellulose or hydroxypropylcellulose; a xyloglucan, particularly one derived from Tamarind seed gum, a glucomannan, particularly Konjac glucomannan; a galactomannan, particularly Locust Bean gum or Guar gum; a side chain branched galactomannan, particularly Xanthan gum; chitosan or a chitosan salt. Other β-1,4-linked polysaccharides having an affinity for cellulose, such as mannan are also preferred.

Xyloglucan polymer is a highly preferred polysaccharide for use in the laundry and/or fabric care compositions of the present invention. Xyloglucan polymer is preferably obtained from tamarind seed polysaccharides. The preferred range of molecular weights for the xyloglucan polymer is from about 10,000 to about 1,000,000 more preferably from about 50,000 to about 200,000.

Polysaccharides, are normally incorporated in the treating composition of the present invention at levels from about 0.01% to about 25%, preferably from about 0.5% to 20%, more preferably from 1 to 15% by weight of the treating composition.

Polysaccharides have a high affinity for binding with cellulose. Without wishing to be bound by theory, it is believed that the binding efficacy of the polysaccharides to cellulose depends on the type of linkage, extent of branching and molecular weight. The extent of binding also depends on the nature of the cellulose (i.e., the ratio of crystalline to amorphous regions in cotton, rayon, linen, etc.).

The natural polysaccharides can be modified with amines (primary , secondary, tertiary), amides, esters, ethers, urethanes, alcohols, carboxylic acids, tosylates, sulfonates, sulfates, nitrates, phosphates and mixtures thereof. Such a modification can take place in position 2, 3 and/or 6 of the saccharide unit. Such modified or derivatised polysaccharides can be included in the compositions of the present invention in addition to the natural polysaccharides.

Nonlimiting examples of such modified polysaccharides include: carboxyl and hydroxymethyl substitutions (e.g. glucuronic acid instead of glucose); amino polysaccharides (amine substitution, e.g. glucosamine instead of glucose); C₁-C₆ alkylated polysaccharides; acetylated polysaccharide ethers; polysaccharides having amino acid residues attached (small fragments of glycoprotein); polysaccharides containing silicone moieties. Suitable examples of such modified polysaccharides are commercially available from Carbomer and include, but are not limited to, amino alginates, such as hexanediamine alginate, amine functionalised cellulose-like O-methyl-(N-1,12-dodecanediamine) cellulose, biotin heparin, carboxymethylated dextran, guar polycarboxylic acid, carboxymethylated locust bean gum, carboxymethylated xanthan, chitosan phosphate, chitosan phosphate sulfate, diethylaminoethyl dextran, dodecylamide alginate, sialic acid, glucuronic acid, galacturonic acid, mannuronic acid, guluronic acid, N-acetylgluosamine, N-acetylgalactosamine, and mixtures thereof.

Especially preferred polysaccharides include cellulose, ether, ester and urethane derivatives of cellulose, particularly cellulose monoacetate, xyloglucans and galactomannans, particularly Locust Bean gum.

It is preferred that the polysaccharide has a total number of sugar units from 10 to 7000, although this figure will be dependent on the type of polysaccharide chosen, at least to some extent.

In the case of cellulose and water-soluble modified celluloses, the total number of sugar units is preferably from 50 to 1 000, more preferably 50 to 750 and especially 200 to 300. The preferred molecular weight of such polysaccharides is from 10 000 to 150000.

In the case of cellulose monoacetate, the total number of sugar units is from 10 to 200, preferably 100 to 150. The preferred molecular weight is from 10 000 to 20 000.

In the case of Locust Bean gum, the total number of sugar units is preferably from 50 to 7000. The preferred molecular weight is from 10 000 to 1000 000.

In the case of xyloglucan, the total number of sugar units is preferably from 1000 to 3000. the preferred molecular weight is from 250 000 to 600 000.

The polysaccharide can be linear, like in hydroxyalkyl cellulose, it can have an alternating repeat like in carrageenan, it can have an interrupted repeat like in pectin, it can be a block copolymer like in alginate, it can be branched like in dextran, or it can have a complex repeat like in xanthan. Descriptions of the polysaccharides are given in “An introduction to Polysaccharide Biotechnology”, by M. Tombs and S. E. Harding, T. J. Press 1998.

Preferred polysaccharides are celluloses or cellulose derivatives of formula (A):

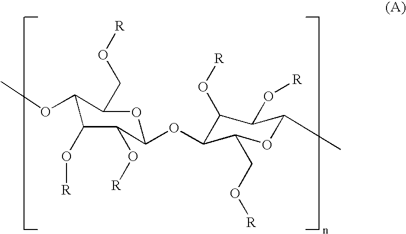

wherein at least one or more R groups are independently selected from groups of formulae:

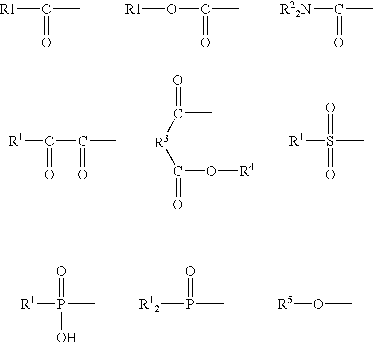

wherein each R¹ is independently selected from C₁₋₂₀ (preferably C₁₋₆) alkyl, C₂₋₂₀ (preferably C₂₋₆) alkenyl (e.g. vinyl) and C₅₋₇ aryl (e.g. phenyl) any of which is optionally substituted by one or more substituents independently selected from C₁₋₄ alkyl, C₁₋₁₂ (preferably C₁₋₄) alkoxy, hydroxyl, vinyl and phenyl groups;

each R² is independently selected from hydrogen and groups R¹ as hereinbefore defined;

R³ is a bond or is selected from C₁₋₄ alkylene, C₂₋₄ alkenylene and C₅₋₇ arylene (e.g. phenylene) groups, the carbon atoms in any of these being optionally substituted by one or more substituents independently selected from C₁₋₁₂ (preferably C₁₋₄) alkoxy, vinyl, hydroxyl, halo and amine groups;

each R⁴ is independently selected from hydrogen, counter cations such as alkali metal (preferably Na) or ½ Ca or ½ Mg, and groups R¹ as hereinbefore defined;

R⁵ is selected from C₁₋₂₀ (preferably C₁₋₆) alkyl, C₂₋₂₀ (preferably C₂₋₆) alkenyl (e.g. vinyl) and C₅₋₇ aryl (e.g. phenyl) any of which is optionally substituted by one or more substituents independently selected from C₁₋₄ alkyl, C₁₋₁₂ (preferably C₁₋₄) alkoxy, hydroxyl, carboxyl, cyano, sulfonato, vinyl and phenyl groups; and

groups R which together with the oxygen atom forming the linkage to the respective saccharide ring forms an ester or hemi-ester group of a tricarboxylic- or higher polycarboxylic- or other complex acid such as citric acid, an amino acid, a synthetic amino acid analogue or a protein;

any remaining R groups being selected from hydrogen and ether substituents.

For the avoidance of doubt, as already mentioned, in formula (A), some of the R groups may optionally have one or more structures, for example as hereinbefore described. For example, one or more R groups may simply be hydrogen or an alkyl group.

Preferred groups may for example be independently selected from one or more of acetate, propanoate, trifluoroacetate, 2-(2-hydroxy-1-oxopropoxy) propanoate, lactate, glycolate, pyruvate, crotonate, isovalerate cinnamate, formatter, salicylate, carbamate, methylcarbamate, benzoate, gluconate, methanesulphonate, toluene, sulphonate, groups and hemiester groups of fumaric, malonic, itaconic, oxalic, maleic, succinic, tartaric, aspartic, glutamic, and malic acids.

Particularly preferred such groups are the monoacetate, hemisuccinate, and 2-(2-hydroxy-1-oxopropoxy)propanoate. The term “monoacetate” is used herein to denote those acetates with a degree of substitution of about 1 or less on a cellulose or other β-1,4 polysaccharide backbone. Thus, “cellulose monoacetate” refers to a molecule that has acetate esters in a degree of substitution of about 1.1 or less, preferably about 1.1 to about 0.5. “Cellulose triacetate” refers to a molecule that has acetate esters in a degree of substitution of about 2.7 to 3.

Cellulose esters of hydroxyacids can be obtained using the acid anhydride in acetic acid solution at 20-30° C. and in any case below 50° C. When the product has dissolved the liquid is poured into water (b.p. 316,160). Tri-esters can be converted to secondary products as with the triacetate. Glycollic and lactic ester are most common.

Cellulose glycollate may also be obtained from cellulose chloracetate (GB-A-320 842) by treating 100 parts with 32 parts of NaOH in alcohol added in small portions.

An alternative method of preparing cellulose esters consists in the partial displacement of the acid radical in a cellulose ester by treatment with another acid of higher ionisation constant (FR-A-702 116). The ester is heated at about 100° C. with the acid which, preferably, should be a solvent for the ester. By this means cellulose acetate-oxalate, tartrate, maleate, pyruvate, salicylate and phenylglycollate have been obtained, and from cellulose tribenzoate a cellulose benzoate-pyruvate. A cellulose acetate-lactate or acetate-glycollate could be made in this way also. As an example cellulose acetate (10 g.) in dioxan (75 ml.) containing oxalic acid (10 g.) is heated at 100° C. for 2 hours under reflux.

Multiple esters are prepared by variations of this process. A simple ester of cellulose, e.g. the acetate, is dissolved in a mixture of two (or three) organic acids, each of which has an ionisation constant greater than that of acetic acid (1.82×10⁻⁵). With solid acids suitable solvents such as propionic acid, dioxan and ethylene dichloride are used. If a mixed cellulose ester is treated with an acid this should have an ionisation constant greater than that of either of the acids already in combination.

A cellulose acetate-lactate-pyruvate is prepared from cellulose acetate, 40 per cent. acetyl (100 g.), in a bath of 125 ml. pyruvic acid and 125 ml. of 85 per cent. lactic acid by heating at 100° C. for 18 hours. The product is soluble in water and is precipitated and washed with ether-acetone. M.p. 230-250° C.

In the case when solubilising groups are attached to the polysaccharide, this is typically via covalent bonding and, may be pendant upon the backbone or incorporated therein. The type of solubilising group may alter according to where the group is positioned with respect to the backbone.

The molecular weight of the substituted polysaccharide part may typically be in the range of 1,000 to 2,000,000, for example 10,000 to 1,500,000.

The Polymer and its Synthesis

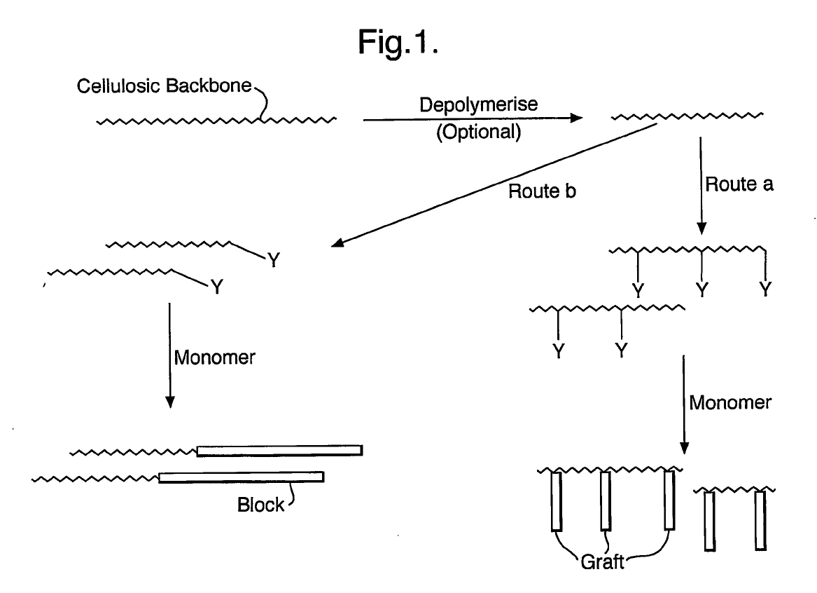

The invention utilises a compound which in most preferred embodiments is a cellulosic graft polymer, which is prepared from control agents for the living or controlled free radical polymerisation of the graft segments. In another aspect, the invention is a cellulosic copolymer, which is prepared from control agents for the living or controlled free radical polymerisation of monomers into blocks, The production of these two categories of polymers is generally shown in FIG. 1. As shown therein, a cellulosic starting material (e.g., cellulosic backbone) is optionally first depolymerised to a desired size. Then following route a in FIG. 1, initiator control agents (designated herein as Y) are attached to at least some middle portions of the cellulosic material. Following route b in FIG. 1, initiator-control agents are attached to at least one terminal end portion of the cellulosic backbone. Desired one or more monomers are then polymerised in a controlled or living-type free radical method to yield cellulosic backbone graft polymers from route a and block copolymers from route b, with the rectangular blocks representing the graft or block polymer segments.

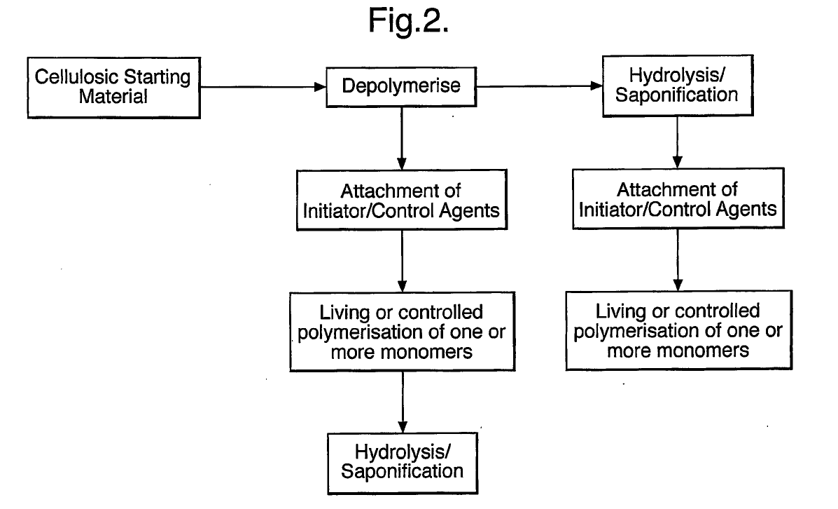

FIG. 2 shows the processes for synthesis of the polymers of this invention in block diagram form. As shown in FIG. 2, the cellulosic starting material is optionally, but typically, depolymerised to obtain a cellulosic material having a desired size. Thereafter, the process proceeds in one of two routes. In a first route, after depolymerisation the cellulosic material is optionally subjected to hydrolysis or saponification, depending on the starting material. The purpose of hydrolysis or saponification is to make the cellulosic material more water soluble (or at least water dispersible by reducing the degree of substitution, as explained more fully below). Following the same first route, the cellulosic material is substituted with one or more initiator-control agents. The substituted material is then subjected to polymerisation conditions with one or more monomers of choice in order to polymerise the one or more monomers at the points of attachment of the initiator control agents. This polymerisation step is preferably performed under living or controlled type kinetics (although some loss of control is conceivable). The alternative second route shown in FIG. 2 is where the hydrolysis or saponification step is performed after the polymerisation step and is an alternative depending on the starting cellulosic material.

Thus, cellulosic based polymers, and other polysaccharide based polymers, can be prepared according to the general schemes indicated in FIG. 2. Basically, they can be graft copolymers composed of a cellulosic backbone and synthetic polymeric chains grafted to it or block copolymers wherein the cellulosic segment is linked to another synthetic polymeric chain at either one or both ends.

As shown in FIG. 2, grafted copolymers are typically prepared by:

1. depolymerising the polysaccharide, preferably cellulosic, backbone material to the desired molecular weight;

2. attaching the control agent along the polysaccharide, preferably cellulosic, backbone;

3. polymerising at least one monomer in a living or controlled free radical polymerisation, with the purpose of growing the grafted chain to a targeted molecular weight; and

4. optionally, saponifying/hydrolysing the polysaccharide, preferably cellulosic, backbone.

Block copolymers are prepared according the same scheme with the exception that the control agents are selectively anchored to the termini of the polysaccharide, preferably cellulosic, chains.

Depolymerization

Polymers utilised in this invention generally have a cellulosic backbone selected from the group consisting of cellulose, modified cellulose and hemi-cellulose. Modified cellulose and hemi-cellulose are used herein consistently with as those of skill in the art would use such terms, including for example, cellulosic materials having at least some β-1,4-linked glucose units in the backbone, such as mannan, glucomannan and xyloglucan. The cellulosic backbone may be naturally occurring and may be straight chained or branched. In preferred embodiments, the cellulosic backbone is cellulose triacetate or cellulose monoacetate. The cellulosic backbone may be obtained from commercial sources, but in preferred embodiments, a cellulosic backbone obtained from such sources is de-polymerized prior to preparation of the grafts or copolymers.

Cellulosic materials are preferably those obtained from the esterification of natural or regenerated cellulose. Cellulose esters such as cellulose mono-, di- and tri-acetate, or as cellulose mono-, di- and tri-propionate are preferred. Depolymerisation is performed according to known procedures. For instance, one can start from microcrystalline cellulose, that is successively hydrolysed in fuming HCl in cellulose oligomers, then isolated and re-acetylated in triacetate cellulose (Flugge L. A et al., J. Am. Chem. Soc. 1999, 121, 7228-7238). This process works well when very low molecular weights are targeted, for example for a degree of polymerisation of about 8 and below. Other processes start from cellulose esters with a DS between 2.7 and 3 (e.g., fully esterified cellulose), which are contacted either with Bronsted acid, such as HBr (De Oliveira W. et al, Cellulose, 1994, 1, 77-86), or Lewis acid such as BF₃ (U.S. Pat. No. 3,386,932). Each of these references is incorporated herein by reference, Molecular weight control of the cellulosic backbone is achieved by adjusting the reaction conditions, like temperature, time of contact and concentration of the acid, etc.

Whether depolymerisation is carried out or not, the cellulosic backbone has a number average molecular weight in the range of from about 3,000 to about 100,000, more preferably in the range of from about 3,000 to about 60,000 and most preferably in the range of from about 3,000 to about 20,000. Depending on the exact type of cellulose, the degree of polymerisation can range from about 15 to about 250, more preferably from about 15 to about 100, and most preferably from about 15 to about 80.

Depending on the starting material (e.g., cellulose triacetate or cellulose monoacetate), the cellulosic backbone polymer optionally may be hydrolysed or saponified. Hydrolysis or saponification may optionally be performed on the graft or block copolymers of this invention after the grafts or blocks have been grown from the cellulosic backbone. The purpose of this step in the process is to provide water solubility or dispersability to the cellulosic graft or block copolymers utilised in this invention. The term “water soluble or dispersible” as used herein means that the graft or block copolymers are either freely soluble in or dispersible (as a stable suspension) in at least water or a buffered water solution. “Soluble” and/or “miscible” herein means that the copolymer dissolves in the solvent or solvents at 25° C. at a concentration of at least about 0.1 mg/mL, more preferably about 1 mg/mL, and most preferably about 2 mg/mL. “Dispersible” means that the copolymer forms a stable suspension (without the addition of further materials such as emulsifiers) when combined with the solvent or solvents at about 25° C. at a concentration of at least about 0.1 mg/mL, more preferably about 1 mg/mL, and most preferably about 2 mg/mL. Hydrolysis or saponification are carried out substantially according to methods known to those of skill in the art. Hydrolysis is carried out by reacting the cellulosic backbone with an acid, such as acetic acid. Generally, the deacetylation/hydrolysis is carried out in a mix of acetic acid, water and methanol at an appropriate temperature (e.g., about 155° C.) in an appropriate vessel (e.g. a sealed reactor). Typical reaction times are 9 to 12 hrs. The product is isolated by precipitation into acetone and yields a water soluble/dispersible form of cellulosic material (acetate DS-0.75-1.25), See, for example, WO 00/22224, which is incorporated herein by reference. Saponification, generally, is carried out by reacting the cellulosic backbone material with a base, such as NaOH or KOH. Typically, a solution of the cellulosic backbone material in a solvent (e.g., dimethylformamide (DMF) or tetrahydrofuran (THF), for example in a concentration of 10 to 25 weight %) is added into an aqueous solution of the base (for example, in a concentration 0.1 M to 1 M preferably between 0.1 M to 0.5M, at temperatures between 25° C. and 80° C., preferably between 40° C. and 60° C. to make up a total polymer concentration of 10000 ppm).

The cellulosic backbone is substituted (sometimes referred to as “activated”) with a desired degree of substitution of initiator-control agent adducts so that grafts or blocks may be polymerised or grown from the sites of attachment of the initiator control agent adducts. Because polymerisation will appear to have occurred between the bond of the initiator and control agent, the initiator fragment or the control agent fragment may be attached to the cellulosic backbone, such that the substituted material may be characterized by the general formula I:

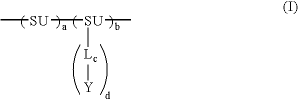

where SU represents a sugar unit in the cellulosic material, L is an optional linker, Y is the initiator control agent adduct or chain transfer agent (collectively generally referred to herein as a “control agent”), a is the number of sugar units that do not have a Y substitution and is typically in the range of from about 3-80, b is the number of sugar units that have at least one Y substitution and is typically in the range of from about 1-25, c is 0 or 1 depending on whether a linker is present, and d is the degree of substitution of Y control agents on a single sugar unit and is typically in the range of from about 1-3. The sugar units may be placed in any order and there may be many more unsubstituted sugar units (SU)ₐ than substituted sugar units (SU)_{b}. Moreover, formula (I) shows the middle sugar units of the cellulosic backbone, but the copolymer embodiment of this invention has the Y substituents placed on at least one terminal end sugar unit. Thus, formula (I) may appear as

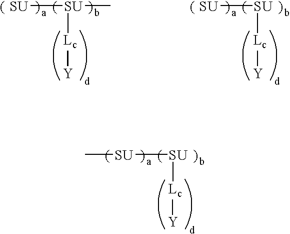

In some preferred embodiments, a, b and d are numbers that will give the graft or block copolymers of this invention the desired level of adherence to the surface or fibre. In other words, a, b and d control the properties of the resultant polymer. Since it is an object of this invention to provide a grafted or copolymer cellulosic material that adheres to cotton or other fibres or surfaces, then control of a, b and c may be critical to the invention.

As those of skill in the art will appreciate, a, b and d are typically determined from a bulk sample by nuclear magnetic resonance (NMR), gel permeation chromatography (GPC) or some other spectroscopic or chromatographic technique. Thus, a and b are average numbers across the bulk sample and they may not be integers. Using formula (I), the number of grafts per chain is calculated by multiplying b times d. The graft density for a bulk sample is determined by the formula (b*d)/(a+b), where the average graft density for a bulk sample is determined by NMR or another spectroscopic technique and (a+b) is determined on average by GPC or another chromatographic technique. These two measurements will allow for calculation of the number of grafts per chain (b*d). In preferred embodiments, graft density for a bulk sample is in the range of from about 0.005 to about 3, more preferably in the range of from about 0.01 to about 1 and even more preferably in the range of from about 0.05 to about 0.15. The number of grafts per chain is preferably in the range of from about 1 to about 75 and more preferably in the range of from about 1 to 20.

In formula (I), Y is the initiator control agent adduct, iniferter or chain transfer agent, which is the portion that provides control of the free radical polymerisation process, and is thus generally referred to herein as the control agent (CA). This portion of the molecule can include an initiating portion or not, depending on the method of polymerisation being employed. One preferred embodiment is where Y is a control agent without an initiating fragment (i.e. -CA). When an initiator fragment is present, Y may be either -I-CA or -CA-I, where CA refers to a control agent moiety and I refers to an initiator moiety or fragment. Therefore the number of grafts can be defined by the number of attachment points of a -I-CA or -CA group. When an initiating fragment is present in Y, the -I-CA embodiment is generally preferred. In addition to the NMR, GPC and other spectroscopic techniques discussed above, the number of Y attachment points may be determined by enzymatic digestion of the cellulosic backbone to glucose. This method is known to those skilled in the art and typically involves a GPC measurement for number average molecular weight with a calculation to obtain the number of chains.

Y may be selected from those control agents that provide living-type kinetics to the polymerisation of at least one monomer from the site of attachment of the control agent. Typically, the control agent must be able to be expelled as or support a free radical. In some embodiments, Y is characterized by the general formula II:

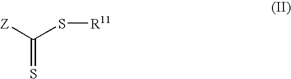

where Z is any group that activates the C═S double bond towards a reversible free radical addition fragmentation reaction and R″ is selected from the group consisting of, generally, any group that can be easily expelled under its free radical form R′●) upon an addition-fragmentation reaction. This control agent can be attached to the cellulosic backbone through either Z or R″, however, for ease these groups are discussed below in terms as if they are not the linking group to the cellulosic backbone (thus, e.g., alkyl would actually be alkylene). R′ is generally selected from the group consisting of optionally substituted hydrocarbyl, and heteroatom-containing hydrocarbyl. More specifically, R″ is selected from the group consisting of optionally substituted alkyl, aryl, alkenyl, alkoxy, heterocyclyl, alkylthio, amino and polymer chains. And still more specifically, R″ is selected from the group consisting of —CH₂Ph, —CH(CH₃)CO₂CH₂CH₃, —CH(CO₂CH₂CH₃)₂, —C(CH₃)₂CN, —CH(Ph)CN and —C(CH₃)₂Ph. Z is typically selected from the group consisting of hydrocarbyl, substituted hydrocarbyl, heteroatom-containing hydrocarbyl and substituted heteroatom containing hydrocarbyl. More specifically, Z is selected from the group consisting of optionally substituted alkyl, aryl, heteroaryl, amino and alkoxy, and most preferably is selected from the group consisting of amino and alkoxy. In other embodiments, Z is attached to C═S through a carbon atom (dithioesters), a nitrogen atom (dithiocarbamate), two nitrogen atoms in series (dithiocarbazate), a sulfur atom (trithiocarbonate) or an oxygen atom (dithiocarbonate). Specific examples for Z can be found in WO 98/01478, WO 99/35177, WO 99/31144, WO 98/58974, U.S. Pat. No. 6, 153, 705 and U.S. patent application Ser. No. 09/676,267, filed 28Sep., 2000, each of which is incorporated herein by reference. Particularly preferred control agents of the type in formula II are those where the control agent is attached through R″ and Z is either, a carbazate, —OCH₂CH₃ or pyrrole attached via the nitrogen atom. As discussed below, linker molecules can be present to attach the C═S group to the cellulose backbone through Z or R″.

In another embodiment, when the -I-CA embodiment is being used, the control agent may be a nitroxide radical. Broadly, the nitroxide radical control agent may be characterized by the general formula —O—NR⁵R⁶, wherein each of R⁵ and R⁶ is independently selected from the group of hydrocarbyl, substituted hydrocarbyl, heteroatom containing hydrocarbyl and substituted heteroatom containing hydrocarbyl; and optionally R⁵ and R⁶ are joined, together in a ring structure. In a more specific embodiment, the control agent may be characterized by the general formula III:

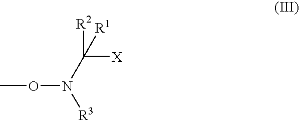

where I is a residue capable of initiating a free radical polymerisation upon homolytic cleavage of the I-O bond, the I residue being selected from the group consisting of fragments derived from a free radical initiator, alkyl, substituted alkyl, alkoxy, substituted alkoxy, aryl, substituted aryl, and combinations thereof; X is a moiety that is capable of destabilizing the control agent on a polymerisation time scale; and each R¹ and R², independently, is selected from the group consisting of alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, silyl, boryl, phosphino, amino, thio, seleno, and combinations thereof; and R³ is selected from the group consisting of tertiary alkyl, substituted tertiary alkyl, aryl, substituted aryl, tertiary cycloalkyl, substituted tertiary cycloalkyl, tertiary heteroalkyl, tertiary heterocycloalkyl, substituted tertiary heterocycloalkyl, heteroaryl, substituted heteroaryl, alkoxy, aryloxy and silyl. Preferably, X is hydrogen. Synthesis of the types of initiator-control agents in formula III is disclosed in, for example, Hawker et al, “Development of a Universal Alkoxyamine for ‘Living’ Free Radical Polymerizations, ” J. Am. Chem. Soc., 1999, 121(16), pp. 3904-3920 and U.S. patent application Ser. No. 09/520,583, filed Mar. 8, 2000 and corresponding International Application No. PCT/US00/06176, all of which are incorporated herein by reference.

Control Agent Attachment

In order to attach Y units (e.g., initiator control agents) to the cellulosic backbone, a linker is typically employed (.e., C═I), designated L in formula I. Linkers are at least dual functional molecules that will react with either a hydroxyl or acetyl ester group of the cellulosic backbone; the linker will also be able to react with a precursor molecule that comprises the Y unit. Typically, a linker molecule has from 2 to 50 non-hydrogen atoms. Linkers (L) may be selected from any of the molecules discussed in this section. Given the molecular weights of the cellulosic backbone and the grafts or blocks that are being added to that backbone, the length of the linker molecule may be chosen to affect or not affect the properties of the graft or block copolymer. In order to reduce the possibility of affecting the properties of the final polymer, the size of the linker molecule may be reduced in some embodiments (e.g., lower molecular weight or steric bulk).

In some preferred embodiments of the invention, the control agent is a thio-carbonylthio derivative with the following structure Z-C(═S)—S, with the control agent linked to the cellulosic material via the Z or S moiety, as discussed above in association with formula II. For graft copolymers, several techniques are available to attach the control agent to the sugar units within the chain backbone.

In a first embodiment, a di-isocyanate linker is used to attach the control agent to the cellulosic backbone. Generally, a bis-isocyanate is reacted with a cellulose ester (having a DS ranging from about 2.5 to 2.7) together with a catalyst, such as a catalytic amount of dibutyldilauryl tin. In some preferred embodiments, the linker is a di-isocyanate compound, having from 8-50 non-hydrogen atoms. Isocyanates are known to react with —OH, —SH and —NH₂ groups, thereby allowing for effective linking of the cellulosic backbone with a properly prepared control agent. Di-isocyanate linkers may be characterized by the general formula: O═C═N—R′—N═C═O, wherein R′ is selected from the group consisting of optionally substituted alkyl and aryl. The pendant NCO groups of the bis-isocyanate are then reacted with an OH-functional control agent Most preferred di-isocyanate linkers include isophorone di-isocyanate (IPDI) and hexamethylene-disocyanate. Other useful di-isocyanate derivatives can be found in “Isocyanates Building Blocks for Organic Synthesis” Aldrich commercial leaflet (PO Box 355 Milwaukee, Wis. 53201 USA), which is incorporated herein by reference. An alternative process comprises forming the chloroformate derivative through phosgenation of the residual OH of the cellulose ester, and then reacting the latter with an hydroxyl (or any other NCO reactive) functional control agent.

The following scheme 1 shows an embodiment of this method:

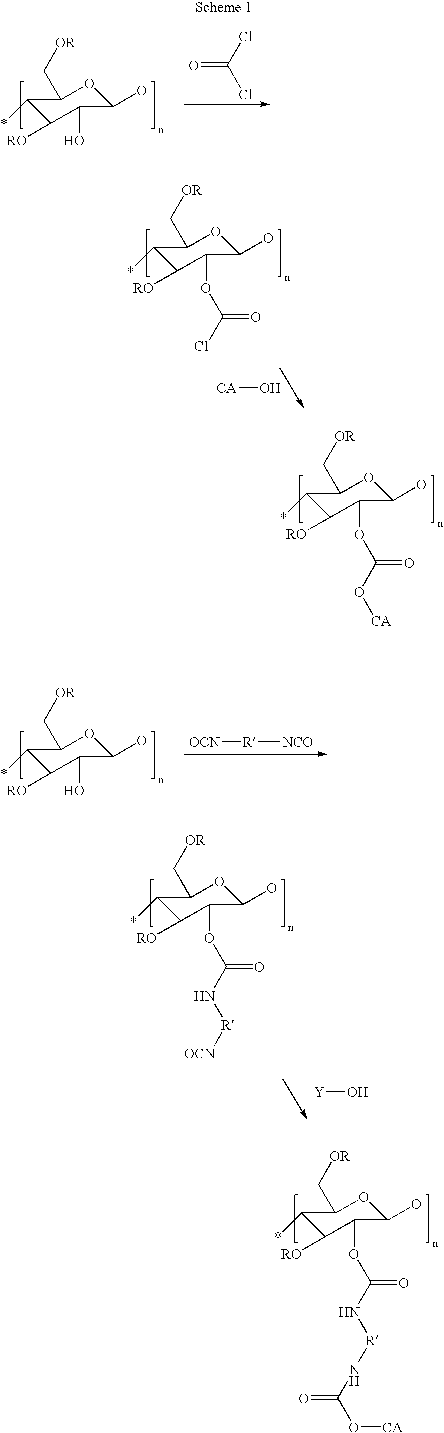

In scheme 1, some embodiments will replace CA with Y, in order to show where the polymerisation may appear to occur. When a saponification or hydrolysis step is involved as a final step in the process (see FIG. 2), then the linkage between the control agent and the cellulose ester backbone is chosen as to resist the saponification conditions. Particularly preferred are urethane or amide linkages that tend to be hydrolytically robust to saponification or hydrolysis conditions. Some examples of OH functional control agents are:

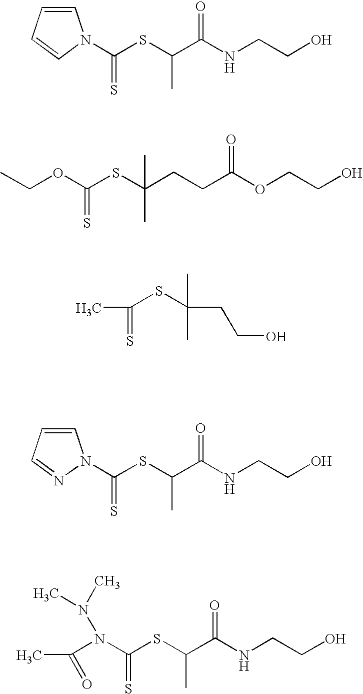

Another embodiment for a linker (L) is the direct attachment of thiocarbonyl-thio control agents to the sugar rings. Generally, in this process the residual OH groups on the cellulosic backbone are first activated by either chlorosulfonyl acids (e.g., tosylates, mesylates, or triflates) or acid chlorides (e.g., para-nitrophenyl chloroformate). Thereafter, the cellulosic material is treated with the metal salt of the corresponding thiocarbonyl-thio compound (e.g., dithiocarbonate, dithiocarbamate) to graft the desired control agents to the cellulosic backbone. This is shown for example in the following scheme 2.

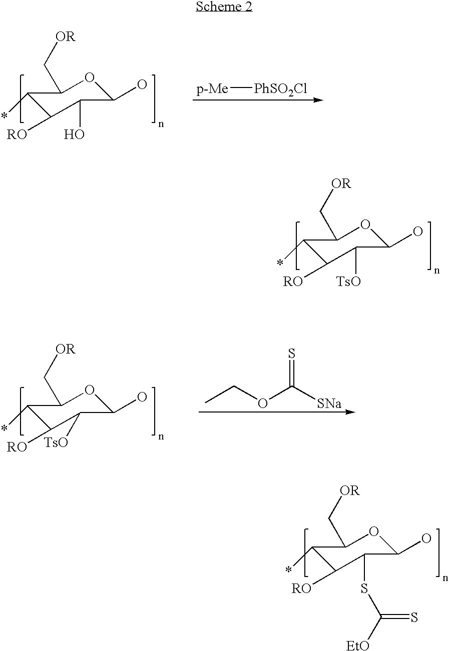

In scheme 2, Ts refers to “tosylate’ and Et refers to “ethyl’.

In other preferred embodiments, block copolymers are prepared, with one of the blocks being the cellulosic material. Anchoring of the control agent to at least one terminal end portion of the cellulosic material is achieved selectively at the C-1 anomeric carbon of the terminal sugar unit by either reductive amination or halogenation.

In the reductive amination route, the reducing terminal glucose residue is converted to an amino group by reacting the cellulosic materials with an excess of the amine or hydroxyamine together with either sodium borohydride or sodium cyanoborohydride. Reduction under high pressure of hydrogen with a Nickel Raney catalyst can also be utilised. Details of these procedures can be found in Danielson S. et al., Glycoconjugate Journal (1986) 3:363-377; Larm O. et al., Carbohydrate Research, 58(1977) 249-251; WO 98/15566; and EP 0 725 082, each of which is incorporated herein by reference. The following scheme 3 presents an example of this pathway:

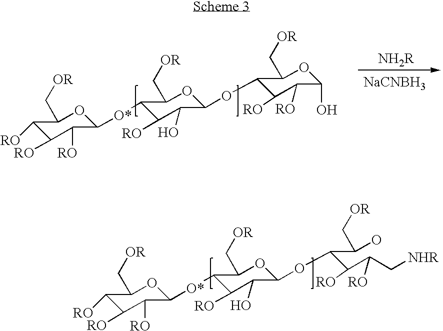

An amino reactive control agent is then condensed to the amine end group. Typical amino reactive groups include isocyanate, isothiocyanate, epoxy, chlorotriazine, carbonate, activated esters (such as N-hydrosuccimide esters), and the like. Isocyanate functional control agents are preferred and one example is given below in scheme 4:

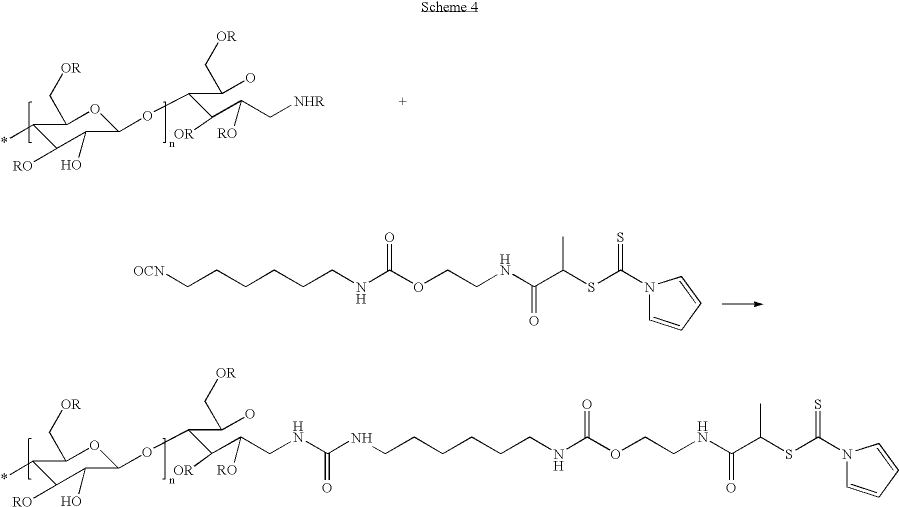

Scheme 4 shows a pyrrole as Z (from formula II). However, those of skill in the art will appreciate that other moieties can be used in this location of the control agent, as discussed above (e.g. the CA-OH compounds listed above).

In the halogenation route to attach the control agents to the terminal end portions of the cellulosic backbone, cellulose esters are depolymerised in a mixture of HBr and acetic anhydride in methylene chloride as described by De Oliveira W. et al, Cellulose, 1994, 1, 77-86, which is incorporated herein by reference. The terminal glycosyl bromide is then displaced by the thiocarbonyl-thio salt of the corresponding control agent, as exemplified in the following scheme 5:

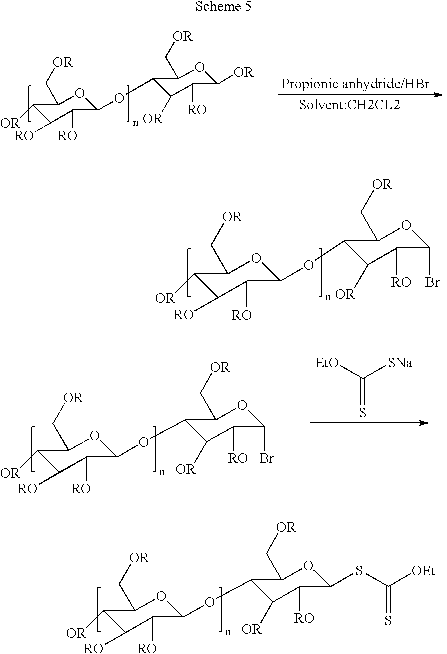

Scheme 5 shows ethoxy as Z (from formula II). However, those of skill in the art will appreciate that other moieties can be used in this location of the control agent, as discussed above. This process typically employs a cellulose triacetate (e.g., a fully esterified cellulosic material) otherwise side-reactions may occur during the control agent attachment step, which may lead to branched polymers. A variant of this process comprises hydrolysing the bromide into OH; the OH-terminated cellulose ester is then coupled with an OH reactive control agent such as described above.

In each of schemes 1-5, the following formula is employed:

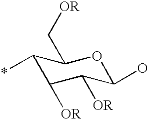

wherein R is selected from the group consisting of hydrogen or acetate and * refers to either an end or additional sugar units. Also, schemes that use the “n” designation are referring to the degree of polymerisation, discussed herein.

Generally, the polymerisation of the graft segments or blocks proceeds under polymerisation conditions. Polymerisation conditions include the ratios of starting materials, temperature, pressure, atmosphere and reaction time. The atmosphere may be controlled, with an inert atmosphere being preferred, such as nitrogen or argon. The molecular weight of the polymer can be controlled via controlled free radical polymerisation techniques or by controlling the ratio of monomer to initiator. The reaction media for these polymerisation reactions is either an organic solvent or bulk monomer or neat. Polymerisation reaction time may be in the range of from about 0,5 hours to about 72 hours, preferably from about 1 hour to about 24 hours and more preferably from about 2 hours to about 12 hours.

When the control agent is of formula II, the polymerisation conditions that may be used include temperatures for polymerisation typically in the range of from about 20° C. to about 110° C., more preferably in the range of from about 50° C. to about 90° C. and even more preferably in the range of from about 70° C. to about 85° C. The atmosphere may be controlled, with an inert atmosphere being preferred, such as nitrogen or argon. The molecular weight of the polymer is controlled via adjusting the ratio of monomer to control agent. Generally, the ratio of monomer to control agent is in the range of from about 200 to about 800. A free radical initiator is usually added to the reaction mixture, so as to maintain the polymerisation rate to an acceptable level. Conversely, a too high free radical initiator to control agent ratio will favour unwanted dead polymer formation, namely pure homopolymers or block copolymers of unknown composition. The molar ratios of free radical initiator to control agent for polymerisation are typically in the range of from about 2:1 to about 0.02:1.

When the control agent is of a nitroxide radical type, polymerisation conditions include temperatures for polymerisation typically in the range of from about 80° C. to about 130° C., more preferably in the range of from about 95° C. to about 130° C. and even more preferably in the range of from about 120° C. to about 130° C. Generally, the ratio of monomer to initiator is in the range of from about 200 to about 800.

Initiators used in the polymerization process with a control agent (and from which I may be derived) may be known in the art, Such initiators may be selected from the group consisting of alkyl peroxides, substituted alkyl peroxides, aryl peroxides, substituted aryl peroxides, acyl peroxides, alkyl hydroperoxides, substituted alkyl hydroperoxides, aryl hydroperoxides, substituted aryl hydroperoxides, heteroalkyl peroxides, substituted heteroalkyl peroxides, heteroalkyl hydroperoxides, substituted heteroalkyl hydroperoxides, heteroaryl peroxides, substituted heteroaryl peroxides, heteroaryl hydroperoxides, substituted heteroaryl hydroperoxides, alkyl peresters, substituted alkyl peresters, aryl peresters, substituted aryl peresters, and azo compounds. Specific initiators include BPO and AIBN. In some embodiments, as discussed above, the I fragment or residue may be selected from the group consisting of fragments derived from a free radical initiator, alkyl, substituted alkyl, alkoxy, substituted alkoxy, aryl, substituted aryl, and combinations thereof. Different I fragments may be preferred depending on the embodiment of this invention being practised. For example, when the di-thio control agents as generally described in formula II are employed for Y equal to -I-CA, the I fragment may be considered to be a portion of the linker, for example, may be considered to be —CH(COOR¹⁰)— where R¹⁰ is selected from the group consisting of hydrocarbyl and substituted hydrocarbyl, and more specifically alkyl and substituted alkyl. Initiation may also be by heat or radiation, as is generally known in the art.

Ideally, the growth of grafts or blocks attached to the cellulosic backbone occurs with high conversion. Conversions are determined by NMR via integration of polymer to monomer signals. Conversions may also be determined by size exclusion chromatography (SEC) via integration of polymer to monomer peak. For UV detection, the polymer response factor must be determined for each polymer/monomer polymerisation mixture. Typical conversions can be 50% to 100%, more specifically in the range of from about 60% to about 90%.

Optionally, the dithio moiety of the control agent of those in formula II can be cleaved by chemical or thermal ways, if one wants to reduce the sulfur content of the polymer and prevent any problems associated with presence of the control agents chain ends, such as odour or discolouration. Typical chemical treatment includes the catalytic or stoichiometric addition of base such as a primary amine, acid or anhydride, or oxidising agents such as hypochloride salts.

As used herein, “block copolymer” refers to a polymer comprising at least two segments having at least two differing compositions, where the monomers are not incorporated into the polymer architecture in a solely statistical or uncontrolled manner. In this invention, at least one of the blocks is a cellulosic block. Although there may be two, three, four or more monomers in a single block-type polymer architecture, it will still be referred to herein as a block copolymer. The block copolymers of this invention may include one or more blocks of random copolymer (sometimes referred to herein as an “R” block) together with one or more blocks of single monomers, so long as there is a cellulosic backbone from which the blocks are centrally tied. Moreover, the random block can vary in composition or size with respect to the overall block copolymer. In some embodiments, for example, the random block will account for between 5 and 80% by weight of the mass of the block copolymer. In other embodiments, the random block R will account for more or less of the mass of the block copolymer, depending on the application. Furthermore, the random block may have a compositional gradient of one monomer to the other (e.g., A:B) that varies across the random block in an algorithmic fashion, with such algorithm being either linear having a desired slope, exponential having a desired exponent (such as a number from 0.1-5) or logarithmic. The random block may be subject to the same kinetic effects, such as composition drift, that would be present in any other radical copolymerisation and its composition, and size may be affected by such kinetics, such as Markov kinetics.

A “block” within the scope of the block copolymers of this invention typically comprises about 5 or more monomers of a single type (with the random blocks being defined by composition and/or weight percent, as described above). In preferred embodiments, the number of monomers within a single block may be about 10 or more, about 15 or more, about 20 or more or about 50 or more. The existence of a block copolymer according to this invention is determined by methods known to those of skill in the art. For example, those of skill in the art may consider nuclear magnetic resonance (NMR) studies, measured increase of molecular weight upon addition of a second monomer to chain-extend a first block, observation of microphase separation, including long range order (determined by X-ray diffraction), microscopy and/or birefringence measurements. Other methods of determining the presence of a block copolymer include mechanical property measurements, (e.g., elasticity of hard/soft/hard block copolymers), thermal analysis and gradient elution chromatography (e.g., absence of homopolymer).

The graft(s) or additional block(s) attached to the cellulosic backbone typically has a number average molecular weight of from 100 to 10,000,000 Da (preferably from 2,000 to 200,000 Da, more preferably from 10,000 to 100,000 Da) and a weight average molecular weight of from 150 to 20,000,000 Da (preferably from 5,000 to 450,000 Da, more preferably from 20,000 to 400,000 Da).

The monomers chosen for the grafts or blocks are typically selected in a manner so as to produce the desired effect on the surface or fibre. For example, the monomers may be chosen for their particular hydrophilic or hydrophobic characteristics.

Hydrophilic monomers include, but are not limited to, acrylic acid, methacrylic acid, N,N-dimethylacrylamide, dimethyl aminoethyl methacrylate, quaternised dimethylaminoethyl methacrylate, methacrylamide, N-t-butyl acrylamide, maleic acid, maleic anhydride and its half esters, crotonic acid, itaconic acid, acrylamide, acrylate alcohols, hydroxyethyl methacrylate, diallyldimethyl ammonium chloride, vinyl ethers (such as methyl vinyl ether), maleimides, vinyl pyridine; vinyl imidazole, other polar vinyl heterocyclics, styrene sulfonate, allyl alcohol, vinyl alcohol (such as that produced by the hydrolysis of vinyl acetate after polymerisation), salts of any acids and amines listed above, and mixtures thereof. Preferred hydrophilic monomers include acrylic acid, N,N-dimethyl acrylamide, dimethylaminoethyl methacrylate, quaternized dimethyl aminoethyl methacrylate, vinyl pyrrolidone, salts of acids and amines listed above, and combinations thereof.

Hydrophobic monomers may be listed above and include, but are not limited to, acrylic or methacrylic acid esters of C₁-C₁₈ alcohols, such as methanol, ethanol, methoxy ethanol, 1-propanol, 2-propanol, 1-butanol, 2-methyl-1-propanol, 1-pentanol, 2-pentanol, 3-pentanol, 2-methyl-1-butanol, 1-methyl-1-butanol, 3-methyl-1-butanol, 1-methyl-1-pentanol, 2-methyl-1-pentanol, 3-methyl-1-pentanol, t-butanol (2-methyl-2-propanol), cyclohexanol, neodecanol, 2-ethyl-1-butanol, 3-heptanol, benzyl alcohol, 2-octanol, 6-methyl-1-heptanol, 2-ethyl-1-hexanol; 3,5 dimethyl-1-hexanol, 3,5,5,-tri-methyl-1hexanol, 1-decanol, 1-dodecanol; 1-hexadecanol, 1-octadecanol, and the like, the alcohols having from about 1 to about 18 carbon atoms, preferably from about 1 to about 12 carbon atoms; styrene; polystyrene macromer, vinyl acetate; vinyl chloride; vinylidene chloride; vinyl propionate; alpha-methylstyrene; t-butylstyrene; butadiene; cyclohexadiene; ethylene; propylene; vinyl toluene; and mixtures thereof. Preferred hydrophobic monomers include n-butyl methacrylate, isobutyl methacrylate, t-butyl acrylate, t-butyl methacrylate, 2-ethylhexyl methacrylate, methyl methacrylate, vinyl acetate, vinyl acetamide, vinyl formamide, and mixtures thereof, more preferably t-butyl acrylate, t-butyl methacrylate, or combinations thereof.

The cellulosic graft or copolymers of this invention may have properties that can be tuned or controlled depending on the desired use of the polymer. Thus, for example, when the water solubility of the chosen graft material is low or poor and the cellulosic backbone is more water soluble than the grafts (e.g., is cellulose mono-acetate), then the polymer may form micelle like structures, with the hydrophobic materials being attracted to each other and the more hydrophilic materials forming an outer ring.

Following the above procedures yields a polymer either having a cellulosic backbone with grafts of controlled structure and composition or a block copolymer or a combination of both. In some embodiments the polymers obtained are novel, which may be characterised by the size of the celluosic backbone, the number of graft chains extending from the backbone and the length of the graft chains. In addition, these grafts are preferably single point attached to the backbone, and in some embodiments preferably, water-soluble. Where control of the polymerisation is partially list, then some of the grafts may be connected to several backbone chains leading to cross-linking. Water solubility is defined above. Cross-linking may be determined for the polymers of this application by light scattering or more specifically dynamic light scattering (DLS). Alternatively, filtration of the polymer sample though an about 0.2 to 0.5 micron filter without inducing a backpressure would, for purposes of this application, indicate a lack of cross-linking in the polymer sample. Also alternatively, other mechanical methods of determining cross-linking may be used, which are known to those of skill in the art. If a polymer passes any of these tests, it is considered substantially free of cross-linking for the purposes of this application, with “substantially” meaning less than or equal to about 20% cross-linked.

Using the above-described parameters, the novel polymers of this application are cellulosic backboned graft polymers which have a degree of substitution (DS) of grafts in the bulk sample in the range of from 0.02 to about 0.15. As discussed above, the DS of graft chains in the bulk sample is dependant on two factors, the length of the cellulosic backbone and number of grafts. Generally, to fit the preferred DS, the cellulosic backbone typically has a molecular weight in the range of from about 10,000 to about 40,000 and the number of grafts can range from about 3 to 12. The general calculation to determine these numbers is that the molecular weight (e.g., either number average or weight average) of the cellulosic backbone is divided by the molecular weight of each sugar unit. This yields the number of sugar units, which is then multiplied by the degree of substitution in the bulk sample to yield number of grafts per cellulosic backbone. In formula form, this is {(Mw backbone/Mw sugar unit)×DS}=number of grafts. The grafts on the cellulosic backbone have a length (i.e., degree of polymerisation) of between 25 and 200 monomer units and more preferably between 50 and 100 monomer units.

The cellulosic backbone is most preferably cellulose monoacetate, but the other cellulosic backbones are not excluded. The grafts can be selected from any of the above-listed monomers and depend on the end use of the polymer. As shown in the examples, the polymers that have this structure tend to have properties that allow for improved adsorption to surface and fibres.

It should be noted that, although the polymer and its synthesis have been described by reference to polymers having a cellulosic backbone, the properties and techniques described are equally applicable to polymers having a different polysaccharide backbone.

Compositions

The graft and copolymers of this invention provide benefits to fibres such as cotton, and other substrates by adhering to the surface during an aqueous treatment process. The level of adsorbancy can be adjusted with the selection of monomers, the graft density and the graft length. The grafts or co-blocks also determine the type of benefit added to the fibre or surface.

Surfactants

Compositions according to the first aspect of the invention must also comprise one or more surfactants suitable for use in laundry cleaning, that is, laundry wash and/or rinsing, products. In the most general sense, these may be chosen from one or more of soap and non-soap anionic, cationic, nonionic, amphoteric and zwitterionic surface-active compounds and mixtures thereof. Many suitable surface-active compounds are available and are fully described in the literature, for example, in “Surface-Active Agents and Detergents”, Volumes I and II, by Schwartz, Perry and Berch.

For those compositions intended as laundry wash products, preferably, the surfactant(s) is/are selected from one or more soaps and synthetic non-soap anionic and non-ionic compounds. Detergent compositions suitable for use in most automatic fabric washing machines generally contain anionic non-soap surfactant, or non-ionic surfactant, or combinations of the two in any suitable ratio, optionally together with soap.

For example, laundry wash compositions of the invention may contain linear alkylbenzene sulphonate anionic surfactants, particularly linear alkylbenzene sulphonates having an alkyl chain length of C₈-C₁₅. It is preferred if the level of linear alkylbenzene sulphonate is from 0 wt % to 30 wt %, more preferably 1 wt % to 25 wt %, most preferably from 2 wt % to 15 wt %.

The laundry wash compositions of the invention may additionally or alternatively contain one or more other anionic surfactants in total amounts corresponding to percentages quoted above for alkyl benzene sulphonates. Suitable anionic surfactants are well-known to those skilled in the art. These include primary and secondary alkyl sulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

The laundry wash compositions of the invention may contain non-ionic surfactant. Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

It is preferred if the level of total non-ionic surfactant is from 0 wt % to 30 wt %, preferably from 1 wt/o to 25 wt %, most preferably from 2 wt % to 15 wt %.

Another class of suitable surfactants comprises certain mono-long chain-alkyl cationic surfactants for use in main-wash laundry compositions according to the invention. Cationic surfactants of this type include quaternary ammonium salts of the general formula R₁R₂R₃R₄N⁺X⁻ wherein the R groups are long or short hydrocarbon chains, typically alkyl, hydroxyalkyl or ethoxylated alkyl groups, and X is a counter-ion (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters).

The choice of surface-active compound (surfactant), and the amount present in the laundry wash compositions according to the invention, will depend on the intended use of the detergent composition. In fabric washing compositions, different surfactant systems may be chosen, as is well known to the skilled formulator, for handwashing products and for products intended for use in different types of washing machine. The total amount of surfactant present will also depend on the intended end use and may be as high as 60 wt %, for example, in a composition for washing fabrics by hand. In compositions for machine washing of fabrics, an amount of from 5 to 40 wt % is generally appropriate. Typically the compositions will comprise at least 2 wt % surfactant e.g. 2-60%, preferably 15-40% most preferably 25-35%.

In the case of laundry rinse compositions according to the invention the surfactant(s) is/are preferably selected from fabric conditioning agents. In fact, conventional fabric conditioning agent may be used. These conditioning agents may be cationic or non-ionic. If the fabric conditioning compound is to be employed in a main wash detergent composition the compound will typically be non-ionic. If used in the rinse phase, they will typically be cationic. They may for example be used in amounts from 0.5% to 35%, preferably from 1% to 30% more preferably from 3% to 25% by weight of the composition.

Preferably the fabric conditioning agent(s) have two long chain alkyl or alkenyl chains each having an average chain length greater than or equal to C₁₆. Most preferably at least 50% of the long chain alkyl or alkenyl groups have a chain length of C₁₈ or above. It is preferred if the long chain alkyl or alkenyl groups of the fabric conditioning agents are predominantly linear.

The fabric conditioning agents are preferably compounds that provide excellent softening, and are characterised by a chain melting Lβ to Lα transition temperature greater than 25° C., preferably greater than 35° C., most preferably greater than 45° C. This Lβ to Lα transition can be measured by DSC as defined in “Handbook of Lipid Bilayers, D Marsh, CRC Press, Boca Raton, Fla., 1990 (pages 137 and 337).

Substantially insoluble fabric conditioning compounds in the context of this invention are defined as fabric conditioning compounds having a solubility less than 1×10⁻³ wt % in demineralised water at 20° C. Preferably the fabric softening compounds have a solubility less than 1×10⁻⁴ wt %, most preferably less than 1×10⁻⁸ to 1×10⁻⁶. Preferred cationic fabric softening agents comprise a substantially water insoluble quaternary ammonium material comprising a single alkyl or alkenyl long chain having an average chain length greater than or equal to C₂₀ or, more preferably, a compound comprising a polar head group and two alkyl or alkenyl chains having an average chain length greater than or equal to C₁₄.

Preferably, the cationic fabric softening agent is a quaternary ammonium material or a quaternary ammonium material containing at least one ester group. The quaternary ammonium compounds containing at least one ester group are referred to herein as ester-linked quaternary ammonium compounds.

As used in the context of the quarternary ammonium cationic fabric softening agents, the term ‘ester group’, includes an ester group which is a linking group in the molecule.

It is preferred for the ester-linked quaternary ammonium compounds to contain two or more ester groups. In both monoester and the diester quaternary ammonium compounds it is preferred if the ester group(s) is a linking group between the nitrogen atom and an alkyl group. The ester groups(s) are preferably attached to the nitrogen atom via another hydrocarbyl group.

Also preferred are quaternary ammonium compounds containing at least one ester group, preferably two, wherein at least one higher molecular weight group containing at least one ester group and two or three lower molecular weight groups are linked to a common nitrogen atom to produce a cation and wherein the electrically balancing anion is a halide, acetate or lower alkosulphate ion, such as chloride or methosulphate. The higher molecular weight substituent on the nitrogen is preferably a higher alkyl group, containing 12 to 28, preferably 12 to 22, e.g. 12 to 20 carbon atoms, such as coco-alkyl, tallowalkyl, hydrogenated tallowalkyl or substituted higher alkyl, and the lower molecular weight substituents are preferably lower alkyl of 1 to 4 carbon atoms, such as methyl or ethyl, or substituted lower alkyl. One or more of the said lower molecular weight substituents may include an aryl moiety or may be replaced by an aryl, such as benzyl, phenyl or other suitable substituents.

Preferably the quaternary ammonium material is a compound having two C₁₂-C₂₂ alkyl or alkenyl groups connected to a quaternary ammonium head group via at least one ester link, preferably two ester links or a compound comprising a single long chain with an average chain length equal to or greater than C₂₀.

More preferably, the quaternary ammonium material comprises a compound having two long chain alkyl or alkenyl chains with an average chain length equal to or greater than C₁₄. Even more preferably each chain has an average chain length equal to or greater than C₁₆. Most preferably at least 50% of each long chain alkyl or alkenyl group has a chain length of C₁₈. It is preferred if the long chain alkyl or alkenyl groups are predominantly linear.

The most preferred type of ester-linked quaternary ammonium material that can be used in laundry rinse compositions according to the invention is represented by the formula (B):

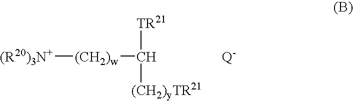

wherein T is

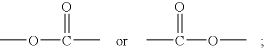

each R²⁰ group is independently selected from C₁₋₄ alkyl, hydroxyalkyl or C₂₋₄ alkenyl groups; and wherein each R²¹ group is independently selected from C₈₋₂₈ alkyl or alkenyl groups; Q⁻ is any suitable counter-ion, i.e. a halide, acetate or lower alkosulphate ion, such as chloride or methosulphate;

w is an integer from 1-5 or is 0; and

y is an integer from 1-5.

It is especially preferred that each R²⁰ group is methyl and w is 1 or 2.

It is advantageous for environmental reasons if the quaternary ammonium material is biologically degradable.

Preferred materials of this class such as 1,2-bis[hardened tallowoyloxy]-3-trimethylammonium propane chloride and their method of preparation are, for example, described in U.S. Pat. No. 4,137,180. Preferably these materials comprise small amounts of the corresponding monoester as described in U.S. Pat. No. 4,137,180 for example 1-hardened tallowoyloxy-2-hydroxy-3-trimethylammonium propane chloride.

Another class of preferred ester-linked quaternary ammonium materials for use in laundry rinse compositions according to the invention can be represented by the formula:

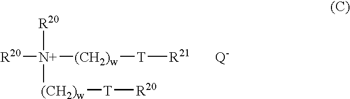

wherein T is

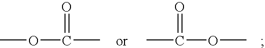

and

wherein R²⁰, R²¹, w, and Q⁻ are as defined above.

Of the compounds of formula (C), di-(tallowyloxyethyl)-dimethyl ammonium chloride, available from Hoechst, is the most preferred. Di-(hardened tallowyloxyethyl)dimethyl ammonium chloride, ex Hoechst and di-(tallowyloxyethyl)-methyl hydroxyethyl methosulphate are also preferred.

Another preferred class of quaternary ammonium cationic fabric softening agent is defined by formula (D):

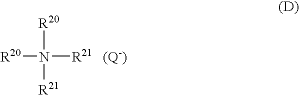

where R²⁰, R²¹ and Q⁻ are as hereinbefore defined.

A preferred material of formula (D) is di-hardened tallow-diethyl ammonium chloride, sold under the Trademark Arquad 2HT.

The optionally ester-linked quaternary ammonium material may contain optional additional components, as known in the art, in particular, low molecular weight solvents, for instance isopropanol and/or ethanol, and co-actives such as nonionic softeners, for example fatty acid or sorbitan esters.

Detergency Builders

The compositions of the invention, when used as laundry wash compositions, will generally also contain one or more detergency builders. The total amount of detergency builder in the compositions will typically range from 5 to 80 wt %, preferably from 10 to 60 wt %.

Inorganic builders that may be present include sodium carbonate, if desired in combination with a crystallisation seed for calcium carbonate, as disclosed in GB 1 437 950 (Unilever); crystalline and amorphous aluminosilicates, for example, zeolites as disclosed in GB 1 473 201 (Henkel), amorphous aluminosilicates as disclosed in GB 1 473 202 (Henkel) and mixed crystalline/amorphous aluminosilicates as disclosed in GB 1 470 250 (Procter & Gamble); and layered silicates as disclosed in EP 164 514B (Hoechst). Inorganic phosphate builders, for example, sodium orthophosphate, pyrophosphate and tripolyphosphate are also suitable for use with this invention.

The compositions of the invention preferably contain an alkali metal, preferably sodium, aluminosilicate builder. Sodium aluminosilicates may generally be incorporated in amounts of from 10 to 70% by weight (anhydrous basis), preferably from 25 to 50 wt %.

The alkali metal aluminosilicate may be either crystalline or amorphous or mixtures thereof, having the general formula: 0.8-1.5 Na₂O. Al₂O₃. 0.8-6 SiO₂.

These materials contain some bound water and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature. Suitable crystalline sodium aluminosilicate ion-exchange detergency builders are described, for example, in GB 1 429 143 (Procter & Gamble). The preferred sodium aluminosilicates of this type are the well-known commercially available zeolites A and X, and mixtures thereof.

The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP 384 070A (Unilever). Zeolite MAP is defined as an alkali metal aluminosilicate of the zeolite P type having a silicon to aluminium ratio not exceeding 1.33, preferably within the range of from 0.90 to 1.33, and more preferably within the range of from 0.90 to 1.20.

Especially preferred is zeolite MAP having a silicon to aluminium ratio not exceeding 1.07, more preferably about 1.00. The calcium binding capacity of zeolite MAP is generally at least 150 mg CaO per g of anhydrous material.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-, di and trisuccinates, carboxymethyloxy succinates, carboxymethyloxymalonates, dipicolinates, hydroxyethyliminodiacetates, alkyl- and alkenylmalonates and succinates; and sulphonated fatty acid salts. This list is not intended to be exhaustive.

Especially preferred organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %.

Builders, both inorganic and organic, are preferably present in alkali metal salt, especially sodium, salt, form.

Bleaches

Laundry wash compositions according to the invention may also suitably contain a bleach system. Fabric washing compositions may desirably contain peroxy bleach compounds, for example, inorganic persalts or organic peroxyacids, capable of yielding hydrogen peroxide in aqueous solution.

Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate.

Especially preferred is sodium percarbonate having a protective coating against destabilisation by moisture. Sodium percarbonate having a protective coating comprising sodium metaborate and sodium silicate is disclosed in GB 2 123 044B (Kao).

The peroxy bleach compound is suitably present in an amount of from 0.1 to 35 wt %, preferably from 0.5 to 25 wt %. The peroxy bleach compound may be used in conjunction with a bleach activator (bleach precursor) to improve bleaching action at low wash temperatures. The bleach precursor is suitably present in an amount of from 0.1 to 8 wt %, preferably from 0.5 to 5 wt %.

Preferred bleach precursors are peroxycarboxylic acid precursors, more especially peracetic acid precursors and pernonanoic acid precursors. Especially preferred bleach precursors suitable for use in the present invention are N,N,N′,N′,-tetracetyl ethylenediamine (TAED) and sodium nonanoyloxybenzene sulphonate. (SNOBS). The novel quaternary ammonium and phosphonium bleach precursors disclosed in U.S. Pat. No. 4,751,015 and U.S. Pat. No. 4,818,426 (Lever Brothers Company) and EP 402 971A (Unilever), and the cationic bleach precursors disclosed in EP 284 292A and EP 303 520A (Kao) are also of interest.

The bleach system can be either supplemented with or replaced by a peroxyacid examples of such peracids can be found in U.S. Pat. No. 4,686,063 and U.S. Pat. No. 5,397,501 (Unilever). A preferred example is the imido peroxycarboxylic class of peracids described in EP A 325 288, EP A 349 940, DE 382 3172 and EP 325 289. A particularly preferred example is phthalimido peroxy caproic acid (PAP). Such peracids are suitably present at 0.1-12%, preferably 0.5-10%.

A bleach stabiliser (transition metal sequestrant) may also be present. Suitable bleach stabilisers include ethylenediamine tetra-acetate (EDTA), the polyphosphonates such as Dequest (Trade Mark) and non-phosphate stabilisers such as EDDS (ethylene diamine di-succinic acid). These bleach stabilisers are also useful for stain removal especially in products containing low levels of bleaching species or no bleaching species.

An especially preferred bleach system comprises a peroxy bleach compound (preferably sodium percarbonate optionally together with a bleach activator), and a transition metal bleach catalyst as described and claimed in EP 458 397A, EP 458 398A and EP 509 787A (Unilever).

Enzymes

Laundry wash compositions according to the invention may also contain one or more enzyme(s). Suitable enzymes include the proteases, amylases, cellulases, oxidases, peroxidases and lipases usable for incorporation in detergent compositions. Preferred proteolytic enzymes (proteases) are catalytically active protein materials which degrade or alter protein types of stains when present as in fabric stains in a hydrolysis reaction. They may be of any suitable origin, such as vegetable, animal, bacterial or yeast origin.

Proteolytic enzymes or proteases of various qualities and origins and having activity in various pH ranges of from 4-12 are available and can be used in the instant invention. Examples of suitable proteolytic enzymes are the subtilisins which are obtained from particular strains of B. Subtilis B. licheniformis, such as the commercially available subtilisins Maxatase (Trade Mark), as supplied by Gist Brocades N. V., Delft, Holland, and Alcalase (Trade Mark), as supplied by Novo Industri A/S, Copenhagen, Denmark.

Particularly suitable is a protease obtained from a strain of Bacillus having maximum activity throughout the pH range of 8-12, being commercially available, e.g. from Novo Industri A/S under the registered trade-names Esperase (Trade Mark) and Savinase (Trade-Mark). The preparation of these and analogous enzymes is described in GB 1 243 785. Other commercial proteases are Kazusase (Trade Mark obtainable from Showa-Denko of Japan), Optimase (Trade Mark from Miles Kali-Chemie, Hannover, West Germany), and Superase (Trade Mark obtainable from Pfizer of U.S.A.).

Detergency enzymes are commonly employed in granular form in amounts of from about 0.1 to about 3.0 wt %. However, any suitable physical form of enzyme may be used.

Other Optional Ingredients

The compositions of the invention may contain alkali metal, preferably sodium carbonate, in order to increase detergency and ease processing. Sodium carbonate may suitably be present in amounts ranging from 1 to 60 wt %, preferably from 2 to 40 wt %. However, compositions containing little or no sodium carbonate are also within the scope of the invention.

Powder flow may be improved by the incorporation of a small amount of a powder structurant, for example, a fatty acid (or fatty acid soap), a sugar, an acrylate or acrylate/maleate copolymer, or sodium silicate. One preferred powder structurant is fatty acid soap, suitably present in an amount of from 1 to 5 wt %.

Yet other materials that may be present in detergent compositions of the invention include sodium silicate; antiredeposition agents such as cellulosic polymers; inorganic salts such as sodium sulphate; lather control agents or lather boosters as appropriate; proteolytic and lipolytic enzymes; dyes; coloured speckles; perfumes; foam controllers; fluorescers and decoupling polymers. This list it hot intended to be exhaustive.

It is often advantageous if soil release or soil suspending polymers are present, for example in amounts in the order of 0.01% to 10%, preferably in the order of 0.1% to 5% and in particular in the order of 0.2% to 3% by weight, such as

cellulose derivatives such as cellulose hydroxyethers, methyl cellulose, ethyl cellulose, hydroxypropyl methyl cellulose, hydroxybutyl methyl cellulose;

polyvinyl esters grafted onto polyalkylene backbones, such as polyvinyl acetates grafted onto polyoxyethylene backbones (EP-A-219 048);

polyvinyl alcohols;

polyester copolymers based on ethylene terephthalate and/or propylene terephthalate units and polyethyleneoxy terephthalate units, with a molar ratio (number of units) of ethylene terephthalate and/or propylene terephthalate/(number of units) polyethyleneoxy terephthalate in the order of 1/10 to 10/1, the polyethyleneoxy terephthalate units having polyethyleneoxy units with a molecular weight in the order of 300 to 10,000, with a molecular weight of the copolyester in the order of 1000 to 100,000;

polyester copolymers based on ethylene terephthalate and/or propylene terephthalate units and polyethyleneoxy and/or polypropyleneoxy units, with a molar ratio (number of units) of ethylene terephthalate and/or propylene terephthalate/(number of units) polyethyleneoxy and/or polypropyleneoxy in the order of 1/10 to 10/1, the polyethyleneoxy and/or polypropyleneoxy units having a molecular weight in the order of 250 to 10,000, with a molecular weight of the copolyester in the order of 1000 to 100,000 (U.S. Pat. No. 3,959,230, U.S. Pat. No. 3,962,152, U.S. Pat. No. 3,893,929, U.S. Pat. No. 4,116,896, U.S. Pat. No. 4,702,857, U.S. Pat. No. 4,770,666, EP-A-253 567, EP-A-201-124);

copolymers of ethylene or propylene terephthalate /polyethyleneoxy terephthalate comprising sulphoisophthaloyl units in their chain (U.S. Pat. No. 4,711,730, U.S. Pat. No. 4,702,857, U.S. Pat. No. 4,713,194);

terephthalic copolyester oligomers having polyalkyleneoxyalkyl sulphonate/sulphoaroyl terminal groups and optionally containing sulphoisophthaloyl units in their chain (U.S. Pat. No. 4,721,580, U.S. Pat. No. 5,415,807, U.S. Pat. No. 4,877,896, U.S. Pat. No. 5,182,043, U.S. Pat. No, 5,599,782, U.S. Pat. No. 4,764,289, EP-A-311 342, WO92/04433, WO97/42293);

sulphonated terephthalic copolyesters with a molecular weight less than 20,000, obtained e.g. from a diester of terephthalic acid, isophthalic acid, a diester of sulphoisophthalic acid and a diol, in particular ethylene glycol (WO95/32997);

polyurethane polyesters, obtained by reaction of a polyester with a molecular weight of 300 to 4000, obtained from a terephthalic acid diester, possibly a sulphoisophthalic acid diester and a diol, on a prepolymer with isocyanate terminal groups, obtained from a polyethyleneoxy glycol with a molecular weight of 600 to 4000 and a diisocyanate (U.S. Pat. No. 4,201,824);

sulphonated polyester oligomers obtained by sulphonation of an oligomer derived from ethoxylated allyl alcohol, dimethyl terephthalate and 1,2-propylene diol, having 1 to 4 sulphonate groups (U.S. Pat. No. 4,968,451).

Use

The composition when diluted in the wash liquor (during a typical wash cycle) will typically give a pH of the wash liquor from 7 to 11, preferably from 7 to 10.5, for a wash product. Treatment of a fabric with a soil-release polymer in accordance with a preferred version of the second aspect of the present invention can be made by any suitable method such as washing, soaking or rinsing.

Typically the treatment will involve a washing or rinsing method such as treatment in the main wash or rinse cycle of a washing machine and involves contacting the fabric with an aqueous medium comprising the composition according to the first aspect of the present invention.

Product Form

Compositions according to the first aspect of the present invention may be formulated in any convenient form, for example as powders, liquids (aqueous or non-aqueous) or tablets. When the compositions are liquids, they may also be provided in encapsulated unit-dose form.

Particulate detergent compositions are suitably prepared by spray-drying a slurry of compatible heat-insensitive ingredients, and then spraying on or post-dosing those ingredients unsuitable for processing via the slurry. The skilled detergent formulator will have no difficulty in deciding which ingredients should be included in the slurry and which should not.

Particulate detergent compositions of the invention preferably have a bulk density of at least 400 g/l, more preferably at least 500 gl. Especially preferred compositions have bulk densities of at least 650 g/litre, more preferably at least 700 g/litre.

Such powders may be prepared either by post-tower densification of spray-dried powder, or by wholly non-tower methods such as dry mixing and granulation; in both cases a high-speed mixer/granulator may advantageously be used. Processes using high-speed mixer/granulators are disclosed, for example, in EP 340 013A, EP 367 339A, EP 390 251A and EP 420 317A (Unilever).

Liquid detergent compositions can be prepared by admixing the essential and optional ingredients thereof in any desired order to provide compositions containing components in the requisite concentrations. Liquid compositions according to the present invention can also be in compact form which means it will contain a lower level of water compared to a conventional liquid detergent.

The present invention will now be explained in more detail by way of the following non-limiting examples.

### EXAMPLES

General

In the examples of this invention, syntheses in inert atmospheres were carried out under a nitrogen or argon atmosphere. Other chemicals were purchased from commercial sources and used as received, except for monomers, which were filtered through a short column of basic aluminum oxide to remove the inhibitor and degassed by applying vacuum. Size Exclusion Chromatography was performed using automated rapid GPC system. In the current setup N,N-dimethylformamide containing 0.1% of trifluoroacetic acid was used as an eluant and polystyrene-based columns. All of the molecular weight results obtained are relative to linear polystyrene standards. ¹H NMR was carried out using a Bruker spectrometer (300 MHz) with CDCl₃ (chloroform-d) as solvent.

A. Preparation of Polymers

### Example 1

### Preparation of Grafted Polymers

Parts A-C of this example proceed substantially according to the following scheme 6:

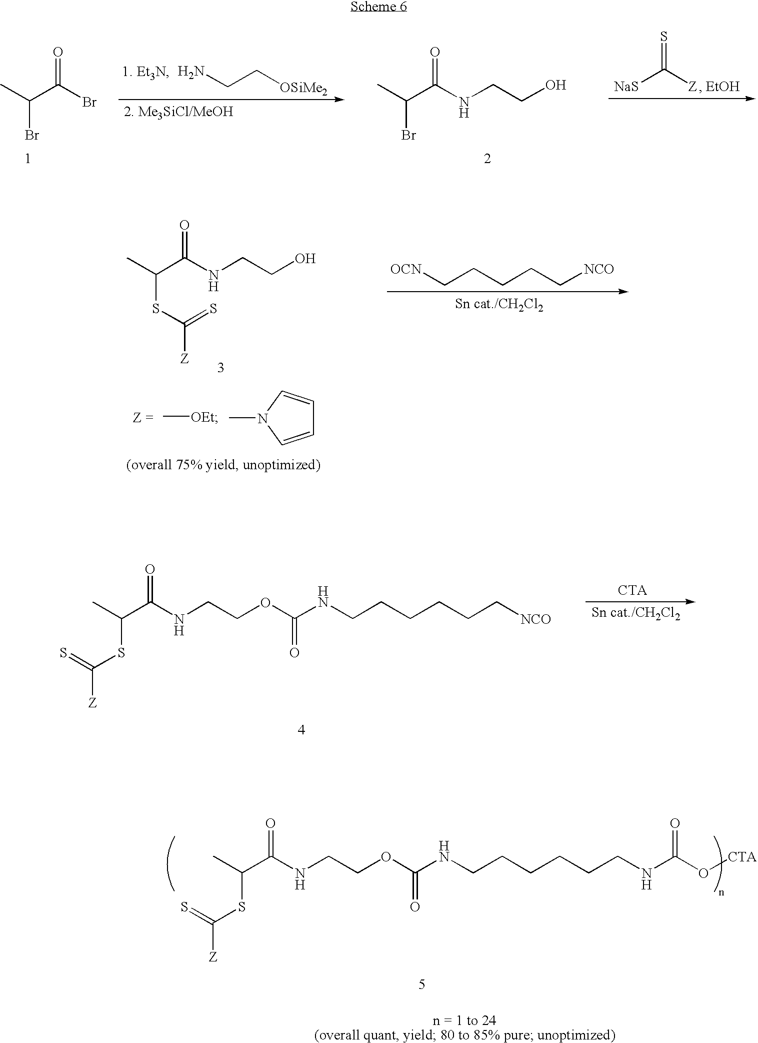

Part A: Synthesis of the Control Agent

2-Bromopropionyl bromide 1 reacted with N-silyl protected ethanolamine to form the corresponding amide. Subsequently deprotection of silyl group occurred in acidic medium during the workup to give the N-hydroxyethyl 2-bromoacrylamide 2 in a quantitative yield. With no further purification, compound 2 was coupled with sodium dithiocarbamate to yield a yellow solid (“Control agent”) compound 3 in 75% yield. All compounds were characterized by ¹H NMR.

Part B: Depolymerization of the Cellulosic Backbone

50 g of cellulose triacetate (“CTA”) (purchased from Aldrich, with a degree of substitution of about 2.7) was dissolved in 1000 ml of dichloroethane (purchased from Aldrich and used without any further purification) under inert atmosphere and heated to 70° C. with vigorous stirring. To this solution 0.5 ml of BF₃. Et₂O was added as a solution in 5 ml of dichloromethane. The mixture was stirred at 70° C. and the reaction was monitored by gel permeation chromatography (GPC). When the desired molecular weight was achieved (about 20,000 number average molecular weight (Mₙ)), the reaction was quenched with triethylamine and allowed to cool to room temperature. The product was isolated by precipitation into ethyl ether or methanol or acetone or ethyl acetate. The product was purified by dissolution in tetrahydrofuran (THF) and re-precipitation from ethyl ether. The product was characterised by ¹H NMR and GPC.

Part C: Attachment of Control Agent to Cellulosic Backbone

Attachment of control agent one end of the linker: 15 g of the control agent (from part A, above) was suspended in 150 ml of dry dichloromethane under an inert atmosphere. 50 ml of the dichloromethane was distilled off and the mixture was cooled to room temperature. 21 ml of hexane diisocyanate was added to the reaction followed by 200 μl of dibutyltin dilaurate. The reaction was stirred at room temperature for 15 minutes. The reaction mixture was then transferred into 1000 ml of dry hexane using a cannula. This mixture was stirred for 10 minutes and filtered. The residue was dissolved in dichloromethane and re-precipitated. The residue was isolated by filtration and dried under vacuum. This produces a control agent attached to one end of the linker, referred to as “control agent-linker”.

20g of depolymerized cellulose triacetate (Mₙ 20,000 from part B, above) was suspended in 100 ml of benzene. The mixture was then distilled to dryness under atmospheric pressure to azeotropically remove water from the cellulose triacetate. 100 ml, of dry dichloromethane was added to the vessel and 50 ml was removed by distillation. 2.5 g of the control agent-linker from the previous paragraph was added to the reaction followed by 200 μl of dibutyl dilaurate. The mixture was then stirred at 40° C. for 12 hours. After this, the reaction mixture was cooled to room temperature, diluted to 150 ml with dichloromethane and precipitated by pouring into methanol. The residue was isolated by filtration and purified by re-precipitation from THF into methanol. The product was characterized by ¹H NMR and GPC.

Part D: Controlled Polymerisation of Vinyl Monomers onto the Cellulosic Backbone

Polymerisation was carried out in a glove box with an inert atmosphere. The control agent modified cellulosic backbone (from part C) was dissolved in degassed dimethylformamide (DMF). To this, the desired vinyl monomer or monomers were added followed by azo-bis-isobutyronitrile (AIBN). The vial was then sealed and the contents stirred at about 60° C. for about 18 hours.

The following Table 1 describes the synthesis of 20 polymers of dimethylacrylamide and/or acrylic acid grafted onto a cellulosic backbone (Mₙ about 20,000) modified with xanthate control agent (with Z=-OEt (see Scheme 6 above)) and with about 5.7 control agents per chain, as measured by NMR. Assuming a number average molecular weight of about 20,000, these polymers have a degree of substitution (DS) of about 0.057. The length of the grafts is controlled by the weight ratio of monomer to cellulosic backbone. The reactants are listed in milligrams and the reactions were carried out in 1 ml vials in accord with the above described procedure.

TABLE 1

| | Cta- | | Dimethyl | | |
|---|---|---|---|---|---|
| | 20K-hdi-5.7-A | Acrylic acid | acrylamide | AIBN | DMF |
| 1 | 50 | 1.25 | 23.75 | 0.117 | 174.8805 |
| 2 | 50 | 6.25 | 18.75 | 0.117 | 174.8805 |
| 3 | 50 | 12.5 | 12.5 | 0.117 | 174.8805 |
| 4 | 50 | 18.75 | 6.25 | 0.117 | 174.8805 |
| 5 | 50 | 23.75 | 1.25 | 0.117 | 174.8805 |
| 6 | 50 | 2.5 | 47.5 | 0.117 | 233.213 |
| 7 | 50 | 12.5 | 37.5 | 0.117 | 233.213 |
| 8 | 50 | 25 | 25 | 0.117 | 233.213 |
| 9 | 50 | 37.5 | 12.5 | 0.117 | 233.213 |
| 10 | 50 | 47.5 | 2.5 | 0.117 | 233.213 |
| 11 | 25 | 2.5 | 47.5 | 0.0585 | 174.939 |
| 12 | 25 | 12.5 | 37.5 | 0.0585 | 174.939 |
| 13 | 25 | 25 | 25 | 0.0585 | 174.939 |
| 14 | 25 | 37.5 | 12.5 | 0.0585 | 174.939 |
| 15 | 25 | 47.5 | 2.5 | 0.0585 | 174.939 |
| 16 | 25 | 5 | 95 | 0.0585 | 291.604 |
| 17 | 25 | 25 | 75 | 0.0585 | 291.604 |
| 18 | 25 | 50 | 50 | 0.0585 | 291.604 |
| 19 | 25 | 75 | 25 | 0.0585 | 291.604 |
| 20 | 25 | 95 | 5 | 0.0585 | 291.604 |

At the end of the reaction, polymers were obtained in each case and the mixtures were diluted to a concentration of about 16.6% polymer in DMF.

Part E: Saponification

Saponification of the cellulosic backbone is carried out by starting with about 16.6% of polymer in DMF added into 0.25M NaOH and stirred at 50° C. This was stirred for 30 minutes and thereafter cooled to room temperature.

B. Compositions and Their Use

### Example 2

Demonstration of adsorption to cotton and effect of architecture on the adsorbed amount. Eight samples of polydimethylacrylamide grafted on cellulose monoacetate (CMA) were prepared substantially according to the methods of Example 1. In this example, the control agent was one where “Z” was pyrrole (see scheme 6, above). The number of grafts and lengths were varied. A small amount of a fluorescent monomer, having the structure

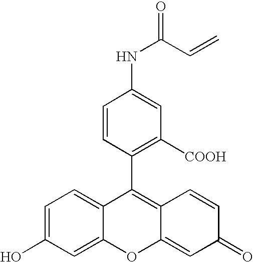

was incorporated in the grafts during polymerisation of the dimethylacrylamide monomer.

The following conditions were employed:

Molecular weight of CMA (Mn)˜20,000

DS of control agent 0.075 and 0.15 onto the CMA

CMA: Monomer weight ratio varies from 1:2 to 1:16

Amount of fluorescent monomer: 0.75 mg in each sample

Total amount of polymer 150.75 mg

Total solids concentration: 33.33%

Amount of AIBN: 10 mole % compared to control agent.

Reaction temperature: 60° C.

Reaction time: 18 hrs

Table 2 shows the amounts used in the polymerisation mixtures. The grafts on the eight samples were polymerised in the following ratios, where “CMA-DS-0.075” represents cellulose monoacetate with a degree of substitution of 0.075 control agents in the cellulosic backbone (a graft density of 6 grafts per cellulosic backbone was measured by NMR) and “CMA-DS-0.15” represents cellulose monoacetate with a degree of substitution of 0.15 control agent in the cellulosic backbone (a graft density of 12 grafts per cellulosic backbone was measured by NMR):

| | CMA-DS-0.15 | CMA-DS.0.075 | | Dimethyl |
|---|---|---|---|---|
| | (mg) | (mg) | DMF (mg) | acrylamide (mg) |
| 1 | — | 50 | 350 | 100 |
| 2 | — | 30 | 350 | 120 |
| 3 | — | 16.67 | 350 | 133.33 |
| 4 | — | 8.82 | 350 | 141.18 |
| 5 | 50 | — | 350 | 100 |
| 6 | 30 | — | 350 | 120 |
| 7 | 16.67 | — | 350 | 133.33 |
| 8 | 8.82 | — | 350 | 141.18 |

Each polymerisation resulted in a cellulose monoacetate graft polydimethylacrylamide polymer. The amount of dimethylacrylamide in the polymerisation mixture determined the graft length.

The polymers were diluted in two steps to achieve a concentration of 200 ppm by weight in a buffered surfactant solution. The composition of the surfactant solution is as follows, with the solvent being demineralised water:

0.6 g/L LAS anionic surfactant ((made from the reaction of dodecylbenzene sulphonic acid (e.g., Petrelab 550 available from Pretresa) and sodium hydroxide (e.g., available from Aldrich) resulting in a ca. 50 wt. % (in water) solution of the sodium salt of the acid, which is referred to as “LAS”).

0.4 g/L R(EO)₇

1.25 g/L Na₂CO₃—JT Baker #3604-01

1.1 g/L STP (sodium triphosphate, available from Aldrich).

1.0 g/L NaCl

0.0882 g/L CaCl₂ 2H₂O—Sigma #C-8106

pH=10.5.

The polymers were prepared at a nominal concentration of 30 wt % solids in DMF, and were used without any subsequent purification to remove solvent, unreacted monomer, etc. In the first dilution step, 66 μl of each crude reaction mixture was added to 2 ml of the surfactant solution, in a 2 ml capacity 96-well polypropylene microliter plate. This gave an initial dilution of 1:30, or a polymer concentration of 1% w/v. The solutions were mixed by repeated aspiration and dispensing from a pipette into the well of the microtiter plate. In the second dilution step, 40 μl of the 1 % w/v solutions were added to 2 ml of the surfactant solution in a second microtiter plate and mixed, giving an additional factor of 50 dilution and a final concentration of 0.02% w/v or 200 ppm w/v.

The polymers were tested for adsorption to cotton fabric using an apparatus for simultaneously contacting different liquids with different regions of a single sheet of fabric.

This apparatus is described in detail in U.S. patent application Ser. No. 09/593,730, filed Jun. 13, 2000, which is incorporated herein by reference. Briefly, six sheets of fabric were clamped between an upper and lower block. The fabric sheets had previously been printed with rubbery, cross-linked ink in microtiter plate pattern using standard screen printing techniques and materials. Both blocks contain 8×12 arrays of square cavities, which are aligned with un-printed regions of the fabrics. When the blocks and fabrics are clamped together, liquids placed in the individual wells do not leak or bleed through to other wells, due to the pressure applied by the blocks in the regions separating the wells, and due to the presence of the cross linked ink in these regions, which fills the pores between the fibres. The liquids are forced to flow back and forth through the fabric by means of a pneumatically actuated thin rubber membrane, which is placed between the fabrics and the lower block. Repeated flexing of the membrane away from and towards the fabrics results in fluid motion through the fabrics.

Six white cotton fabrics were tested simultaneously in a single washing apparatus. 400 μl of the 200 ppm polymer/surfactant solutions were placed in the corresponding wells in the washing apparatus. The liquids were flowed through the fabrics for 1 hour at room temperature, with a flow cycle time of approximately 0.5 seconds per complete cycle. After one hour, the free liquid in the cells was poured off, and the apparatus was immersed briefly in tap water to further remove free polymer solution. The blocks were then separated, and the fabrics were removed, separated, and thoroughly rinsed in 6 litres of tap water. The fabrics were allowed to air dry for 24 hours.

The amount of adsorbed polymer was determined by fluorescence imaging. Fluorescence imaging was performed by mounting the sample on a stage in a light-tight enclosure. Near-UV excitation (˜365 nm) was provided by a pair of 8 watt UV fluorescent lamps mounted above and to the side of the sample on adjustable mounts. The total irradiance incident upon the sample was ˜1.8 mW/cm² as measured with a calibrated radiometer (Minolta UM-1w/UM-36 detector). Rejection of undesired reflected light was performed with a glass bandpass filter (Oriel part # 59850) having a centre wavelength of 520 nm, maximum transmission of 52%, and FWHM bandwidth of ˜90 nm, mounted directly in front of the imaging lens. The photoluminescence of the samples was collected with an imaging grade lens of 60 mm focal length (Micro Nikkor) and imaged on a thermoelectrically cooled, 1152×1242 pixel, front illuminated, research grade focal plane array CCD detector (available from Princeton Instruments) under computer control. The exposure time was 20 seconds.

The images were analysed on a computer using a program which allows the user to define a centroid position for the top left and bottom right library element; centroids for the remaining elements are then automatically generated using a simple gridding algorithm. The user also manually defines the size of a rectangular area around each centroid which is to be included In the analysis. Both the total number of counts within the sampled area and the average counts per pixel are calculated and stored, for each element in the grid. The latter number is used for comparisons between libraries, since the sampling area is set manually for each image and is not constant from one library to the next.

To calibrate the relationship between the amount of adsorbed polymer and the fluorescence signal, known amounts of the polymers were deposited on a second piece of fabric. This was done by first preparing a series of solutions at known polymer concentrations, beginning with a 1% wt concentration and diluting progressively by factors of two for a total of eight concentrations. This was done for all eight poly(DMA-graft-CMA) polymers being tested, for a total of 64 test solutions, 1 ml of each contained in an 8×8 array of cells in a 2 ml microtiter plate. For each solution, 5 μl was pipetted directly onto the corresponding square of the second fabric, and allowed to dry. The total amount of polymer deposited can be calculated from the product of the solution concentration times the volume deposited (Table 2, below). The average mass of fabric in each square is 7.5 mg. The calibration sample with deposited polymers was imaged in the fluorescence system described above under identical conditions to the “test” fabrics containing the adsorbed graft polymers.

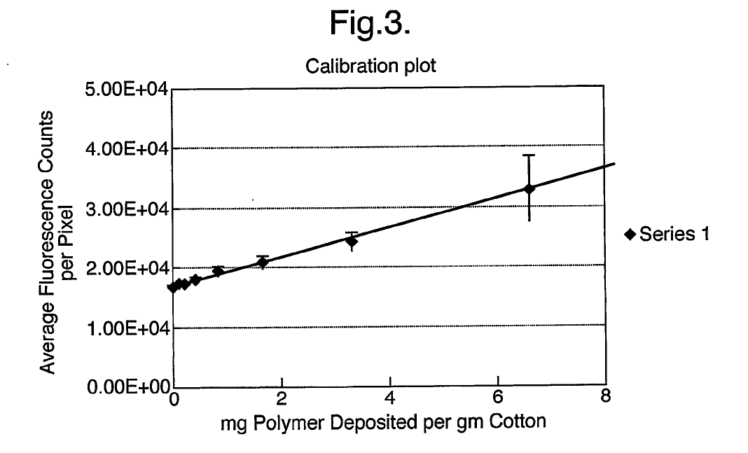

The calibration results are shown in Table 2 and FIG. 3. The fluorescence measurements for a given polymer concentration were averaged over the eight different polymers tested, which all contain approximately the same amount of fluorescent monomer per mass of polymer.

| | | Polymer | | Mg polymer | | |
|---|---|---|---|---|---|---|
| Solution | Volume | mass | One cotton | deposited | Average | Std. Error, |
| mass | deposited, | deposited, | square | per gm | counts per | from 8 |
| fraction | μl | mg | mass | cotton | pixel | samples |
| 1.00E−02 | 5 | 5.00E−02 | 0.0075 | 6.67E+00 | 3.29E+04 | 1.90E+03 |
| 5.00E−03 | 5 | 2.50E−02 | 0.0075 | 3.33E+00 | 2.43E+04 | 5.13E+02 |
| 2.50E−03 | 5 | 1.25E−02 | 0.0075 | 1.67E+00 | 2.09E+04 | 3.70E+02 |
| 1.25E−03 | 5 | 6.25E−03 | 0.0075 | 8.33E0−01 | 1.95E+04 | 2.52E+02 |
| 6.25E−04 | 5 | 3.13E−03 | 0.0075 | 4.17E−01 | 1.81E+04 | 1.45E+02 |
| 3.13E−04 | 5 | 1.56E−03 | 0.0075 | 2.08E−01 | 1.73E+04 | 1.34E+02 |
| 1.56E−04 | 5 | 7.81E−04 | 0.0075 | 1.04E−01 | 1.74E+04 | 9.26E+01 |
| 7.81E−05 | 5 | 3.91E−04 | 0.0075 | 5.21E−02 | 1.70E+04 | 7.32E+01 |
| 0.00E+00 | 5 | 0.00E+00 | 0.0075 | 0.00E+00 | 1.68E+04 | 1.13E+02 |

Referring to FIG. 3, a straight line. was fitted to the calibration data, yielding the relationship:

counts per pixel=a+b*(mg polymer/gram cotton)=1.7E+04+1.97E+03*(mg polymer/gram cotton).

The parameter a gives the number of counts observed for cotton squares carrying no dye, and contains contributions from the dark current of the CCD, any intrinsic fluorescence from the undyed fabric (including any chemicals used in manufacture and/or processing of the fabric), and any of the UV excitation which passes through the filter.

In practice the value of a was found to vary slightly from one fabric array to the next and was determined for each fabric as an average divided by (or “over”) all cells not carrying any dye (i.e., “blanks”). Thus for the test cells, to which the dye-tagged graft polymers were allowed to adsorb from solution, the amount of adsorbed polymer was determined from the averaged number of counts per pixel as

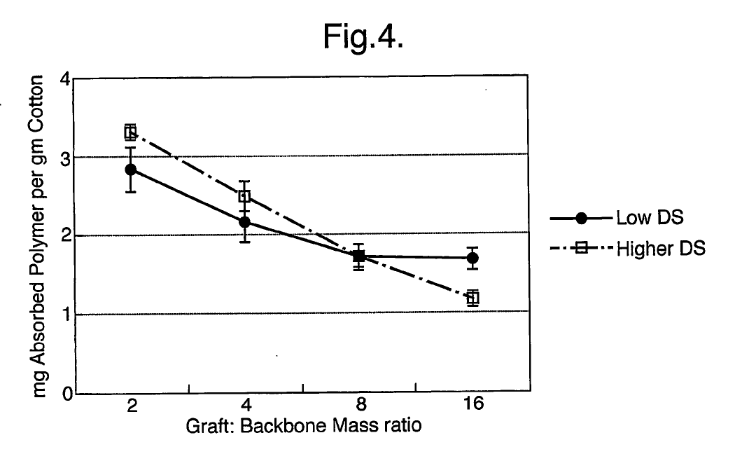

mg polymer/gram cotton=(counts per pixel−a)/b

where the same slope value b-1970 was used for all samples, but the value of the intercept a was determined from the blanks by averaging for each 8×12 fabric array tested. The results of processing this data are shown in FIG. 4 (in units of mg polymer/gram cotton), averaged over all four fabrics tested, and including error bars which represent the standard error calculated from the four measurements. As FIG. 4. demonstrates, the amount of adsorbed polymer decreases gradually as the length of the grafts is increased over a wide range.

Separate experiments were done in order to demonstrate that free dye in solution binds weakly or not at all to the cotton fabric, and that poly(dimethylacrylamide) homopolymers containing dye do not adsorb significantly to the cotton fabric.

### Example 3

### Effect of Graft Architecture on the Adsorbed Amount

A variety of different polymers were grafted from cellulose monacetate (CMA), with different degrees of substitution of the grafts and different degrees of polymerisation of the grafts. The monomers used for the grafts were dimethylacrylamide (DMA), trishydroxymethylmethylacrylamide (THMMA), acrylamide methylpropane sulphonic acid triethylamine salt (AMPS:Et3N) and N-carboxymethyl dimethylaminopropyl acrylamide (N-carbDMAPA). The graft chains were present in seven different degrees of substitution across the bulk sample, namely DS of 0.012, 0.023, 0.04, 0.072, 0.125, 0.18 and 0.27. For each of the first 4 degrees of substitution, five graft polymers were prepared with different degrees of polymerisation (DP) of the grafts, with DP's of 25, 50, 100, 200 and 400 being targeted. For each of the last 3 degrees of substitution, four graft polymers were prepared with different degrees of polymerisation of the grafts, with DP's of 25, 50, 100 and 200 being targeted. The polymerisation proceeded substantially according to the methods of Examples 1 and 2.

In this example, the control agent was one where “Z” was pyrrole (see scheme 6 above). 0.5 mol % of a fluorescent monomer (structure shown below)

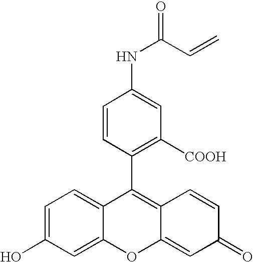

was incorporated in all the grafts during polymerisation of the grafts. CMA was used as a 20 wt % solution in DMF. Dimethylacrylamide was used as a 50% solution in DMF. Trishydroxymethylmethylacrylamide was used as a 20% solution in DMF. Acrylamidomethylpropanesulfonic acid triethylamine salt was used as a 20% solution in DMF. N-Carboxymethyldimethylaminopropylacrylamide was used as a 20% solution in water. AIBN was used as a solution in DMF.

The following procedure is representative for the synthesis of all other polymers in this example: for CMA-DS-0.012 and monomer DMA at a DP=25: in an inert N₂ atmosphere CMA (89.21 mg) and dimethylacrylamide (10.79 mg) were mixed in a vial. To this AIBN (0.089 mg) was added and the mixture was heated to 65° C. and stirred for 18 hours. The reaction mixture was then diluted to 10 wt % with DMF.

Other than DMF, the following tables 4-10 provide the amounts of reactants used in each polymerisation mixture.

TABLE 4

| DS | DP | CMA-Pyrrole-0.012 | AIBN | DMA | THMMA | AMPS:Et3N | N-CarbDMAPA |
|---|---|---|---|---|---|---|---|
| 0.012 | 25 | 89.21 | 0.089 | 10.79 | 0 | 0 | 0 |
| 0.012 | 50 | 80.53 | 0.161 | 19.47 | 0 | 0 | 0 |
| 0.012 | 100 | 67.41 | 0.27 | 32.59 | 0 | 0 | 0 |
| 0.012 | 200 | 50.84 | 0.407 | 49.16 | 0 | 0 | 0 |
| 0.012 | 400 | 34.08 | 0.546 | 65.92 | 0 | 0 | 0 |
| 0.012 | 25 | 82.41 | 0.083 | 0 | 17.59 | 0 | 0 |
| 0.012 | 50 | 70.09 | 0.14 | 0 | 29.91 | 0 | 0 |
| 0.012 | 100 | 53.95 | 0.216 | 0 | 46.05 | 0 | 0 |
| 0.012 | 200 | 36.94 | 0.296 | 0 | 63.06 | 0 | 0 |
| 0.012 | 400 | 22.65 | 0.363 | 0 | 77.35 | 0 | 0 |
| 0.012 | 25 | 72.7 | 0.073 | 0 | 0 | 27.3 | 0 |
| 0.012 | 50 | 57.1 | 0.114 | 0 | 0 | 42.9 | 0 |
| 0.012 | 100 | 39.96 | 0.16 | 0 | 0 | 60.04 | 0 |
| 0.012 | 200 | 24.97 | 0.2 | 0 | 0 | 75.03 | 0 |
| 0.012 | 400 | 14.27 | 0.229 | 0 | 0 | 85.73 | 0 |
| 0.012 | 25 | 80.31 | 0.08 | 0 | 0 | 0 | 19.69 |
| 0.012 | 50 | 67.1 | 0.134 | 0 | 0 | 0 | 32.9 |
| 0.012 | 100 | 50.49 | 0.202 | 0 | 0 | 0 | 49.51 |
| 0.012 | 200 | 33.77 | 0.271 | 0 | 0 | 0 | 66.23 |
| 0.012 | 400 | 20.32 | 0.325 | 0 | 0 | 0 | 79.68 |

TABLE 5

| DS | DP | CMA-Pyrrole-0.023 | AIBN | DMA | THMMA | N-carbDMAPA | AMPS:Et3N |
|---|---|---|---|---|---|---|---|
| 0.023 | 25 | 80.9 | 0.158 | 19.1 | 0 | 0 | 0 |
| 0.023 | 50 | 67.93 | 0.266 | 32.07 | 0 | 0 | 0 |
| 0.023 | 100 | 51.44 | 0.402 | 48.56 | 0 | 0 | 0 |
| 0.023 | 200 | 34.62 | 0.541 | 65.38 | 0 | 0 | 0 |
| 0.023 | 400 | 20.94 | 0.655 | 79.06 | 0 | 0 | 0 |
| 0.023 | 25 | 70.59 | 0.138 | 0 | 29.41 | 0 | 0 |
| 0.023 | 50 | 54.55 | 0.213 | 0 | 45.45 | 0 | 0 |
| 0.023 | 100 | 37.5 | 0.293 | 0 | 62.5 | 0 | 0 |
| 0.023 | 200 | 23.08 | 0.361 | 0 | 76.92 | 0 | 0 |
| 0.023 | 400 | 13.04 | 0.408 | 0 | 86.96 | 0 | 0 |
| 0.023 | 25 | 57.7 | 0.113 | 0 | 0 | 0 | 42.31 |
| 0.023 | 50 | 40.54 | 0.159 | 0 | 0 | 0 | 59.46 |
| 0.023 | 100 | 25.42 | 0.199 | 0 | 0 | 0 | 74.58 |
| 0.023 | 200 | 14.56 | 0.228 | 0 | 0 | 0 | 85.44 |
| 0.023 | 400 | 7.85 | 0.246 | 0 | 0 | 0 | 92.15 |
| 0.023 | 25 | 67.63 | 0.132 | 0 | 0 | 32.37 | 0 |
| 0.023 | 50 | 51.09 | 0.2 | 0 | 0 | 48.91 | 0 |
| 0.023 | 100 | 34.31 | 0.268 | 0 | 0 | 65.69 | 0 |
| 0.023 | 200 | 20.71 | 0.324 | 0 | 0 | 79.29 | 0 |
| 0.023 | 400 | 11.55 | 0.361 | 0 | 0 | 88.45 | 0 |

TABLE 6

| DS | DP | CMA-Pyrrole-0.04 | AIBN | DMA | THMMA | AMPS:Et3N | N-carbDMAPA |
|---|---|---|---|---|---|---|---|
| 0.04 | 25 | 68.64 | 0.261 | 31.48 | 0 | 0 | 0 |
| 0.04 | 50 | 52.14 | 0.396 | 47.86 | 0 | 0 | 0 |
| 0.04 | 100 | 35.26 | 0.536 | 64.74 | 0 | 0 | 0 |
| 0.04 | 200 | 21.41 | 0.651 | 78.59 | 0 | 0 | 0 |
| 0.04 | 400 | 11.99 | 0.729 | 88.01 | 0 | 0 | 0 |
| 0.04 | 25 | 55.24 | 0.21 | 0 | 44.76 | 0 | 0 |
| 0.04 | 50 | 38.16 | 0.29 | 0 | 61.84 | 0 | 0 |
| 0.04 | 100 | 23.58 | 0.359 | 0 | 76.42 | 0 | 0 |
| 0.04 | 200 | 13.37 | 0.406 | 0 | 86.63 | 0 | 0 |
| 0.04 | 400 | 7.16 | 0.436 | 0 | 92.84 | 0 | 0 |
| 0.04 | 25 | 41.22 | 0.157 | 0 | 0 | 58.78 | 0 |
| 0.04 | 50 | 25.96 | 0.197 | 0 | 0 | 74.04 | 0 |
| 0.04 | 100 | 14.92 | 0.227 | 0 | 0 | 85.08 | 0 |
| 0.04 | 200 | 8.06 | 0.245 | 0 | 0 | 91.94 | 0 |
| 0.04 | 400 | 4.2 | 0.255 | 0 | 0 | 95.8 | 0 |
| 0.04 | 25 | 51.8 | 0.197 | 0 | 0 | 0 | 48.2 |
| 0.04 | 50 | 34.95 | 0.266 | 0 | 0 | 0 | 65.05 |
| 0.04 | 100 | 21.18 | 0.322 | 0 | 0 | 0 | 78.82 |
| 0.04 | 200 | 11.84 | 0.36 | 0 | 0 | 0 | 88.16 |
| 0.04 | 400 | 6.29 | 0.383 | 0 | 0 | 0 | 93.71 |

TABLE 7

| DS | DP | CMA-Pyrrole-0.072 | AIBN | DMA | THMMA | N-carbDMAPA | AMPS:Et3N |
|---|---|---|---|---|---|---|---|
| 0.072 | 25 | 56.79 | 0.358 | 43.21 | 0 | 0 | 0 |
| 0.072 | 50 | 39.66 | 0.5 | 60.34 | 0 | 0 | 0 |
| 0.072 | 100 | 24.73 | 0.623 | 75.27 | 0 | 0 | 0 |
| 0.072 | 200 | 14.11 | 0.711 | 85.89 | 0 | 0 | 0 |
| 0.072 | 400 | 7.59 | 0.765 | 92.41 | 0 | 0 | 0 |
| 0.072 | 25 | 42.68 | 0.269 | 0 | 57.32 | 0 | 0 |
| 0.072 | 50 | 27.13 | 0.342 | 0 | 72.87 | 0 | 0 |
| 0.072 | 100 | 15.69 | 0.396 | 0 | 84.31 | 0 | 0 |
| 0.072 | 200 | 8.514 | 0.429 | 0 | 91.49 | 0 | 0 |
| 0.072 | 400 | 4.45 | 0.448 | 0 | 95.55 | 0 | 0 |
| 0.072 | 25 | 29.73 | 0.187 | 0 | 0 | 0 | 70.27 |
| 0.072 | 50 | 17.46 | 0.22 | 0 | 0 | 0 | 82.54 |
| 0.072 | 100 | 9.56 | 0.241 | 0 | 0 | 0 | 90.44 |
| 0.072 | 200 | 5.02 | 0.253 | 0 | 0 | 0 | 94.98 |
| 0.072 | 400 | 2.58 | 0.26 | 0 | 0 | 0 | 97.42 |
| 0.072 | 25 | 39.33 | 0.248 | 0 | 0 | 60.67 | 0 |
| 0.072 | 50 | 24.48 | 0.309 | 0 | 0 | 75.52 | 0 |
| 0.072 | 100 | 13.94 | 0.352 | 0 | 0 | 86.06 | 0 |
| 0.072 | 200 | 7.5 | 0.378 | 0 | 0 | 92.5 | 0 |
| 0.072 | 400 | 3.89 | 0.393 | 0 | 0 | 96.11 | 0 |

TABLE 8

| DS | DP | CMA-Pyrrole-0.125 | AIBN | DMA | THMMA | N-carbDMAPA | AMPS:Et3N |
|---|---|---|---|---|---|---|---|
| 0.125 | 25 | 43.69 | 0.466 | 56.31 | 0 | 0 | 0 |
| 0.125 | 50 | 27.95 | 0.597 | 72.05 | 0 | 0 | 0 |
| 0.125 | 100 | 16.25 | 0.694 | 83.75 | 0 | 0 | 0 |
| 0.125 | 200 | 8.84 | 0.755 | 91.16 | 0 | 0 | 0 |
| 0.125 | 25 | 30.53 | 0.326 | 0 | 69.47 | 0 | 0 |
| 0.125 | 50 | 18.02 | 0.385 | 0 | 81.98 | 0 | 0 |
| 0.125 | 100 | 9.9 | 0.423 | 0 | 90.1 | 0 | 0 |
| 0.125 | 200 | 5.21 | 0.445 | 0 | 94.79 | 0 | 0 |
| 0.125 | 25 | 19.98 | 0.213 | 0 | 0 | 0 | 80.02 |
| 0.125 | 50 | 11.1 | 0.237 | 0 | 0 | 0 | 88.9 |
| 0.125 | 100 | 5.88 | 0.251 | 0 | 0 | 0 | 94.12 |
| 0.125 | 200 | 3.03 | 0.259 | 0 | 0 | 0 | 96.97 |
| 0.125 | 25 | 27.68 | 0.295 | 0 | 0 | 72.32 | 0 |
| 0.125 | 50 | 16.06 | 0.343 | 0 | 0 | 83.94 | 0 |
| 0.125 | 100 | 8.73 | 0.373 | 0 | 0 | 91.27 | 0 |
| 0.125 | 200 | 4.57 | 0.39 | 0 | 0 | 95.43 | 0 |

TABLE 9

| DS | DP | CMA-Pyrrole-0.18 | AIBN | DMA | THMMA | N-carbDMAPA | AMPS:Et3N |
|---|---|---|---|---|---|---|---|
| 0.18 | 25 | 38.56 | 0.509 | 61.44 | 0 | 0 | 0 |
| 0.18 | 50 | 23.89 | 0.63 | 76.11 | 0 | 0 | 0 |
| 0.18 | 100 | 13.56 | 0.716 | 86.44 | 0 | 0 | 0 |
| 0.18 | 200 | 7.28 | 0.768 | 92.72 | 0 | 0 | 0 |
| 0.18 | 25 | 26.23 | 0.346 | 0 | 73.77 | 0 | 0 |
| 0.18 | 50 | 15.09 | 0.398 | 0 | 84.91 | 0 | 0 |
| 0.18 | 100 | 8.16 | 0.431 | 0 | 91.84 | 0 | 0 |
| 0.18 | 200 | 4.26 | 0.449 | 0 | 95.74 | 0 | 0 |
| 0.18 | 25 | 16.81 | 0.222 | 0 | 0 | 0 | 83.19 |
| 0.18 | 50 | 9.17 | 0.242 | 0 | 0 | 0 | 90.83 |
| 0.18 | 100 | 4.81 | 0.254 | 0 | 0 | 0 | 95.19 |
| 0.18 | 200 | 2.46 | 0.26 | 0 | 0 | 0 | 97.54 |
| 0.18 | 25 | 23.64 | 0.312 | 0 | 0 | 76.36 | 0 |
| 0.18 | 50 | 13.4 | 0.354 | 0 | 0 | 86.6 | 0 |
| 0.18 | 100 | 7.18 | 0.379 | 0 | 0 | 92.82 | 0 |
| 0.18 | 200 | 3.73 | 0.393 | 0 | 0 | 96.27 | 0 |

TABLE 10

| DS | DP | CMA-Pyrrole-0.27 | AIBN | DMA | THMMA | N-carbDMAPA | AMPS:Et3N |
|---|---|---|---|---|---|---|---|
| 0.27 | 25 | 32.35 | 0.56 | 67.65 | 0 | 0 | 0 |
| 0.27 | 50 | 19.3 | 0.668 | 80.7 | 0 | 0 | 0 |
| 0.27 | 100 | 10.68 | 0.74 | 89.32 | 0 | 0 | 0 |
| 0.27 | 200 | 5.64 | 0.782 | 94.36 | 0 | 0 | 0 |
| 0.27 | 25 | 21.32 | 0.369 | 0 | 78.68 | 0 | 0 |
| 0.27 | 50 | 11.93 | 0.413 | 0 | 88.07 | 0 | 0 |
| 0.27 | 100 | 6.34 | 0.439 | 0 | 93.66 | 0 | 0 |
| 0.27 | 200 | 3.28 | 0.454 | 0 | 96.72 | 0 | 0 |
| 0.27 | 25 | 13.34 | 0.231 | 0 | 0 | 0 | 86.66 |
| 0.27 | 50 | 7.15 | 0.248 | 0 | 0 | 0 | 92.85 |
| 0.27 | 100 | 3.71 | 0.257 | 0 | 0 | 0 | 96.29 |
| 0.27 | 200 | 1.89 | 0.262 | 0 | 0 | 0 | 98.11 |
| 0.27 | 25 | 19.08 | 0.331 | 0 | 0 | 80.92 | 0 |
| 0.27 | 50 | 10.55 | 0.365 | 0 | 0 | 89.45 | 0 |
| 0.27 | 100 | 5.57 | 0.386 | 0 | 0 | 94.43 | 0 |
| 0.27 | 200 | 2.86 | 0.397 | 0 | 0 | 97.14 | 0 |

Conversions were spot checked by NMR for selected samples and graft polymers of DMA and TRIS were analysed by aqueous GPC. The DS for grafts across the bulk sample were measured by NMR according to the discussion in this specification. Each polymerisation resulted in a cellulose monoacetate graft polymer. The amount of monomer in the polymerisation mixture determined the graft length.

Using the parallel deposition contacting apparatus and method described in Example 2, after synthesis, the reaction mixtures were topped off with solvent to bring the total polymer concentration to a nominal value of 12.5 wt % in all wells (100 mg polymer in 800 μl solvent). These solutions were used without any subsequent purification to remove solvent, unreacted monomer, etc. The polymers were diluted in two steps to achieve an ultimate concentration of 200 ppm by weight in a buffered surfactant solution. The composition of the surfactant solution is as follows, with the solvent being demineralised water:

0.6 g/L LAS anionic surfactant ((made from the reaction of dodecylbenzene sulphonic acid (e.g., Petrelab 550 available from Pretresa) and sodium hydroxide (e.g., available from Aldrich) resulting in a ca. 50 wt. % (in water) solution of the sodium salt of the acid, which is referred to as “LAS”).

0.4 g/L R(EO)₇

1.25 g/L Na₂CO₃—J T Baker #3604-01

1.1 g/L STP (sodium triphosphate, available from Aldrich).

1.0 g/L NaCl

0.0882 g/L CaCl₂ 2H₂O—Sigma #C-8106

pH=10.5.

In the first dilution step, 32 μl of each polymer solution was added to 2 ml of the surfactant solution, in a 2 ml capacity 96-well polypropylene microtiter plate. This gave an initial dilution of 1:62.5, for a polymer concentration of 0.2 wt %. The solutions were mixed by multi-well magnetic stirring. In the second dilution step, 40 μl of the 0.2 wt % solutions and 360 μl of the surfactant solution were added together directly in the apparatus used for screening adsorption in parallel format (described in Example 2). The final polymer concentration is thus a nominal 0.02 wt % or 200 ppm by weight.

The liquids (sample/surfactant solutions) were flowed through the fabrics for 1 hour at room temperature, with a flow cycle time of approximately 0.5 seconds per complete cycle. After one hour, the free liquid in the cells was poured off, and the apparatus was immersed briefly in tap water to further remove free polymer solution. The blocks were then separated, and the fabrics were removed, separated, and thoroughly rinsed in 6 litres of tap water. The fabrics were allowed to air dry for 24 hours.

Each square of the rest fabrics has a mass of approximately 7.5 mg, so the total fabric mass per well is approximately 45 mg. The mass of sample/surfactant solution in each well is approximately 400 mg (400 μl volume), containing a polymer mass fraction of 0.02% or a polymer mass of 0.08 mg. Thus the maximum amount of polymer which can be deposited on the fabric is 0.08 mg/45 mg=1.8 mg polymer per gram of fabric. In order to calculate from the fluorescence signals the amount of polymer actually deposited from the wash, additional fabrics were prepared by directly depositing controlled amounts of the polymers on squares of the test fabrics. The solutions at 0./2 wt % polymer were used for this purpose. A volume of approximately 3.5 μl of each solution was deposited, carrying a total polymer mass of 0.007 mg and giving polymer deposition relative to the fabric in the amount (0.007 mg polymer per square)/(7.5 mg fabric per square)=0.9 mg/gm. This is one half the maximum possible amount of polymer that could be deposited under the test conditions.

The amount of deposited polymer was determined by fluorescence imaging as described in Example 2, but in this example, the f-stop value was f4 and the exposure time was 500 msec. A background image was obtained by taking an exposure with the UV illumination turned off. The effects of non-uniform UV illumination were accounted for by imaging a uniform fluorescent target (Peel-N-Stick Glow Sheeting, manufactured by ExtremeGlow, http://www.extremeglow.com) under the same irradiation and exposure conditions used for imaging the fabrics. The number of counts in a pixel in an experiment image was corrected by first subtracting the number of counts in the corresponding background image pixel, and then dividing by the number of counts in the corresponding uniform target pixel.

The corrected images were analysed on a computer using a program that allows the user to define a centroid position for the top left and bottom right library element. Centroids for the remaining elements are then automatically generated using a simple gridding algorithm. The user also manually defines the size of a circular area around each centroid which is to be included in the analysis. Both the total number of counts within the sampled area and the average counts per pixel are calculated and stored, for each element in the grid. The latter number is used for comparisons between libraries, since the sampling area is set manually and is not necessarily constant from one library to the next. See, for example, WO 00/60529 for disclosure of such a program, which is incorporated herein by reference.

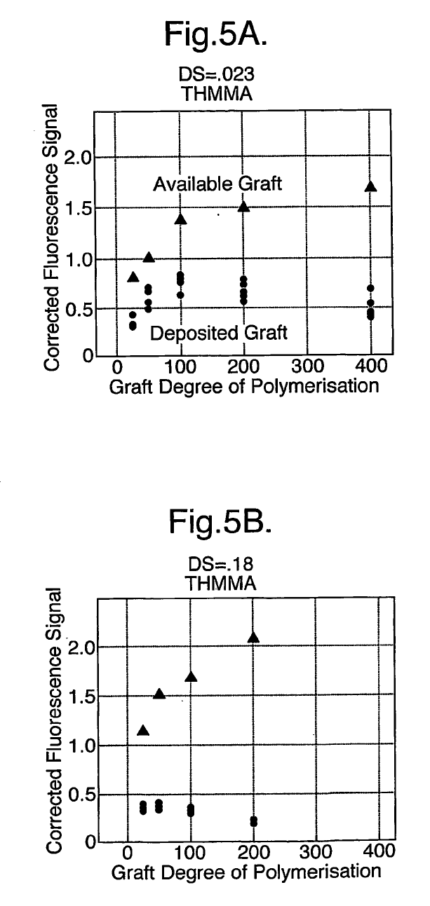

FIG. 5 shows a subset of the data, where DS is equal to 0.023 (FIG. 5A) and 0.18 (FIG. 5B). The lower points in each plot represent the signal from the experimental samples, and the upper points (shown as triangles “▴”) represent twice the signal from the control samples, i.e., the signal which would occur if all polymer were deposited. The upper points thus represent the amount of graft available in solution, and the lower points represent the amount of graft actually deposited on the fabric from the deposition step. From FIG. 5A, the amount of deposited grafted polymer reaches a maximum at about DP=100 and then decreases, even though the amount of graft available for deposition continues to increase. From FIG. 5B, the amount of deposited graft polymer is much less than for DS=0.023, even though the amount of available graft is in all cases larger. Also the amount of deposited polymer essentially decreases monotonically with increasing DP, even though the amount of available graft is increasing monotonically. Similar data was obtained for the other tested graft polymers in this example, for example for dimethylacrylamide grafts, with DS values of 0.012 and 0.125, the trends of available vs. adsorbed polymer were'similar to those observed for THMMA grafts.

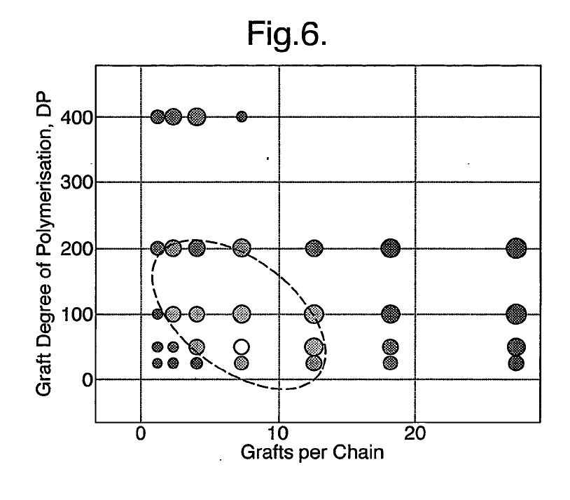

FIG. 6 summarises the results for all of the polymers with THMMA grafts. The x-axis is the number of grafts per chain (=DS*100) and the y-axis is the targeted graft degree of polymerisation, DP. The size of the data points is proportional to twice the signal from the “control” sample, and the relative shade of the data points represents the fluorescence signal from the experimental samples. The size of the points increases monotonically with both DP and DS, because the graft makes up a larger fraction of the polymer as each of these variables increases. The region where the point interiors are lighter represents the region in which the deposition of the grafts is optimised or maximised. An oval has been drawn in FIG. 6 around the region where an anti-correlation exists between the optimum values of DS and DP—as DS is increased, the value of DP which gives optimum deposition decreases, which represents the approximate region where strong deposition occurs.

### Example 4

### Clothes Care

Materials

Materials were synthesised from CMA modified with the pyrrole control agent

| | | control | DP of | | |
|---|---|---|---|---|---|
| Code | graft material | agent DS | grafts | Mw | Mn |
| DMA50 | dimethylacrylamide | 0.072 | 50 | 27000 | 13000 |
| DMA200 | dimethylacrylamide | 0.025 | 200 | 39000 | 22000 |
| TRIS50 | trishyhdroxymethylacrylamide | 0.072 | 50 | 21000 | 12000 |
| TRIS200 | trishydroxymethylacrylamide | 0.025 | 200 | 26000 | 16000 |
| AMMPS50 | acrylamidomethylpropanesulphonic | 0.072 | 50 | | |
| | acid: triethylamine | | | | |
| | salt | | | | |
| AMMPS200 | acrylamidomethylpropanesulphonic acid: | 0.025 | 200 | | |
| | triethylamine | | | | |
| | salt | | | | |
| Zwitter50 | N-carboxymethyldimethylaminopropaneacrylamide | 0.072 | 50 | | |
| Zwitter200 | N-carboxymethyldimethylaminopropaneacrylamide | 0.025 | 200 | | |

DMA = dimethylacrylamide
TRIS = tris-hydroxymethylmethylacrylamide
AMMPS = acrylamidomethylpropanesulfonic acid (triethylamine salt)
Zwitter = N-carboxymethyldimethylaminopropaneacrylamide

1. Test Protocols

Linitester DTI Method

6 Linitester pots were filled with the following reagents and cloths:

| | | Pot 2-5 | |
|---|---|---|---|
| | Pot 1 | 4 different | Pot 6 |
| | CMA | polysaccharides | Control |
| Demineralised water | 160 mls | 160 mls | 160 mls |
| 10 g/l surfactant | 20 mls | 20 mls | 20 mls |
| stock (LAS:A7/50:50) | | | |
| 0.1 M buffer stock | 20 mls | 20 mls | 20 mls |
| White Cotton Monitor | ˜5.77 g | ˜5.77 g | ˜5.77 g |
| (20 × 20 cm (5.77 g)) | | | |
| Direct Red Cloth | ˜5.77 g | ˜5.77 g | ˜5.77 g |
| (1% dyed no fixer) | | | |
| (20 × 20 cm) | | | |
| 0.4 g/l CMA | 0.08 g | N/A | N/A |
| 0.4 g/l experimental | N/A | 0.08 g | N/A |
| polysaccharides | | | |
| Total liquor volume | 200 mls | 200 mls | 200 mls |

Liquor to cloth ratio 17:1

The white cotton cloth was desized, mercerised, bleached, non-fluorescent cotton prepared via method 1.20 in Docfind. The direct red 80 was 1% dyed from stock.

The 0.1M buffer stock contained 0.08 M Na₂CO₃+0.02 M NaHCO₃. This gives pH≈10.5-10.0 at 0.01M in the final liquor. The surfactant stock contained 50:50 wt % LAS: Synperonic A7. The surfactant stock delivers 1 g/l total surfactant in the final liquor.

All the experiment's liquors were added to their respective containers except for the cloths and the polysaccharide samples. Next the cloths and the polysaccharides were added to their respective containers and the wash run for 30 minutes in the Linitester set at 40° C. and 40 rpm. After 30 minutes a sample of the liquor was removed from the containers and stored in glass vials. In total there were 6 pots (1 control, 1 with unmodified CMA for comparison and 4 modified polysaccharides). The cloths were then removed; rinsed in demineralised water twice and then line dried for 30 minutes.

This procedure was repeated 4 more times to give results over 5 washes. After 5 washes the cloths were ironed and then stored in the humidity controlled room at 20° C. and 65% humidity for 24 hours. This ensured a degree of control over the moisture within the samples.

Colour Analysis (Colour Fading & Dye Transfer Inhibition)

The reflectance spectrum of the cloths were measured after each wash cycle, using the ICS Texicon Spectraflash. Settings were UV excluded from 420 nm, Specular included, Large aperture, 4 cloth thickness. Readings were also taken from a non-treated piece of the same fabrics (Direct Red and white) to compare against. The reflectance spectra were used to calculate CIELAB)E and % colour strength values for the white and red cloths respectively.

Kawabata Suite Shear Hysterisis (Softness/Anti-Wrinkle)

Fabric was measured according to the standard instruction manual for this instrument. Testing was performed with the warp direction perpendicular to the motion of the clamping bars. The instrument outputted the measurements as average values of two replicates with the figures for 2HG5, (Hysteresis at 5° of shear). Those skilled in the art will know that the 2HG5 value is a good predictor of softness and anti-wrinkle properties of the fabric.

Crease Recovery Angle (CRA) (Anti-Wrinkle Benefit)

Measurements were performed using the “Shirley” Crease Recovery Angle apparatus (U.S. Pat. No. 1,554,803) with six replicates for each treatment according to BS:EN 22313:1992. Fabric was tested only in the warp direction on pieces 5×2.5 cm. All pieces were handled using tweezers to ensure no contamination. Results are reported as the average of the measurements.

Residual Extension (Dimensional Stability)

The residual extension was determined using an Inströn Testometric (trade mark) tester:

| | |
|---|---|
| Sample size: | 150 mm × 50 mm |
| Clamp width: | 25 mm |
| Stretch area: | 100 mm × 25 mm |
| Elongation rate: | 100 mm/min |
| Extension cycle: | Begin at rest with 0 kg force |
| | Extend until 0.2 kg force is attained |
| | Return to 0 kg force |

2. Experimental Results

Key

| | |
|---|---|
| + | significant benefit |
| − | significant negative |
| = | statistically indistinguishable |

Anti-Wrinkle Benefit

| | | Performance Compared to | |
|---|---|---|---|
| Treatment | Crease recovery angle | no treatment | unmodified CMA |
| Control50 | 65.8 | n/a | n/a |
| Control200 | 70.7 | n/a | n/a |
| CMA50 | 64.3 | = | n/a |
| CMA200 | 71.2 | = | n/a |
| DMA 50 | 73.2 | + | + |
| DMA200 | 68.0 | − | − |
| TRIS50 | 76.8 | + | + |
| TRIS200 | 70.0 | = | = |
| AMMPS50 | 71.7 | = | + |
| AMMPS200 | 69.7 | = | = |
| Zwitter50 | 70.8 | + | + |
| Zwitter200 | 69.7 | − | = |

Colour Fading

Performance
Compared to

| | % colour | no | unmodified |
|---|---|---|---|
| Treatment | strength | treatment | CMA |
| Control50 | 83.1 | n/a | n/a |
| Control200 | 77.0 | n/a | n/a |
| CMA50 | 86.8 | = | n/a |
| CMA200 | 83.7 | + | n/a |
| DMA 50 | 79.9 | = | − |
| DMA200 | 77.9 | = | = |
| TRIS50 | 80.1 | = | − |
| TRIS200 | 80.0 | = | = |
| AMMPS50 | 81.9 | = | = |
| AMMPS200 | 80.0 | = | = |
| Zwitter50 | 80.0 | + | − |
| Zwitter200 | 80.0 | − | = |

Dye Transfer Inhibition

Performance Compared to

| Treatment | Delta E | no treatment | unmodified CMA |
|---|---|---|---|
| Control50 | 44.8 | n/a | n/a |
| Control200 | 45.5 | n/a | n/a |
| CMA50 | 33.8 | + | n/a |
| CMA200 | 34.6 | + | n/a |
| DMA 50 | 34.3 | + | = |
| DMA200 | 37.8 | + | − |
| TRIS50 | 37.0 | + | − |
| TRIS200 | 40.0 | + | − |
| AMMPS50 | 43.6 | = | − |
| AMMPS200 | 44.2 | = | − |
| Zwitter50 | 38.2 | + | − |
| Zwitter200 | 41.9 | + | − |

Softness/Anti-Wrinkle

Performance Compared to

| Treatment | 2HE5 | no treatment | unmodified CMA |
|---|---|---|---|
| Control50 | 6.35 | n/a | n/a |
| Control200 | 7.37 | n/a | n/a |
| CMA50 | 7.17 | − | n/a |
| CMA200 | 7.27 | = | n/a |
| DMA 50 | 6.49 | = | = |
| DMA200 | 7.45 | = | + |
| TRIS50 | 6.66 | = | = |
| TRIS200 | 6.67 | + | + |
| AMMPS50 | 6.87 | = | = |
| AMMPS200 | 7.73 | = | = |
| Zwitter50 | 6.43 | = | + |
| Zwitter200 | 7.42 | = | = |

Dimensional Stability

| | |
|---|---|
| Residual | Performance Compared to |

| Treatment | Extension | no treatment | unmodified CMA |
|---|---|---|---|
| Control50 | 3.41 | n/a | n/a |
| Control200 | 3.40 | n/a | n/a |
| CMA50 | 3.55 | = | n/a |
| CMA200 | 3.40 | = | n/a |
| DMA 50 | 3.27 | = | = |
| DMA200 | 3.54 | = | = |
| TRIS50 | 3.55 | = | + |
| TRIS200 | 3.01 | = | = |
| AMMPS50 | 3.94 | = | = |
| AMMPS200 | 3.27 | = | = |
| Zwitter50 | 2.93 | + | + |
| Zwitter200 | 3.18 | = | = |

### Example 5

### Soil Release

1. Test Protocol

Conditions: Tergotometer, 100 rpm, 23° C.

PRE-WASH: 6 3″×3″ desized cotton squares, in 1 litre of wash liquor (liquor: cloth ca. 200:1)

wash liquor: 1 litre of wash liquour contains 0.6 g/l LAS, 0.75 g/l Na2CO3, 0.6 g/l NaCl, 0.66 g/l STP, made up in demineralised water.

agitated for 20 mins

wash liquor decanted off

Rinse: 1 litre of demineralised water.

Agitated for 5 mins

Liquor decanted off, cloths removed and placed on racks to dry

NB: cloths NOT wrung.

Before staining, cloths are reflected using GretagMacbeth Coloreye

STAINING: Dirty motor oil (DMO) diluted to 15 wt. % in toluene.

0.1 ml of stain applied by pipette to each

3″×3″ square. These were then left to dry on racks in an oven (40° C.) for 1 hour

After staining, cloths are reflected using GretagMacbeth Coloreye

MAIN WASH & rinse: as pre-wash except no polymer was present.

After washing, cloths are dried and reflected using GretagMacbeth Coloreye.

ANALYSIS: results are obtained by extracting R460 values of the cloths

1. before staining (R_{clean})

2. after staining (Rₛₜₐᵢₙ)

3. after final washing (R_{washed})

delta (Δ) R is calculated for all samples including control (no polymer treatment):

R_{washed}−Rₛₜₐᵢₙ

ΔΔR is then calculated for quick comparison to the control

ΔR_{polymer}−ΔR_{control}

2. Experimental Results

| cloth | | ΔR (washed-soiled) | ΔΔR |
|---|---|---|---|
| 1 | control | 15.5 | — |
| 2 | AMMPS 50 | 16.2 | 0.7 |
| 3 | TRIS 50 | 16.7 | 1.2 |
| 4 | Zwitter 50 | 17.1 | 1.6 |

Key:
AMMPS 50 = CMA grafted with Acrylamidomethylpropanesulphonic acid (triethylamine salt), graft DP = 50,
TRIS 50 = CMA grafted with Tris-hydroxymethylmethylacrylamide (Mw 21k, Mn 12k), graft DP = 50,
Zwitter 50 = CMA grafted with N-carboxymethylDimethylaminopropaneacrylamide, graft DP = 50,

It is to be understood that the above description is intended to be illustrative and not restrictive. Many embodiments will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated herein by reference for all purposes.

1. A laundry cleaning composition comprising a graft polymer benefit agent and at least one additional laundry cleaning ingredient, the graft polymer benefit agent comprising a polysaccharide backbone and a plurality of graft chains extending from said backbone, each of said plurality of graft chains having a degree of polymerisation between 5 and 250, wherein said graft polymer is substantially free of cross-linking and has a degree of substitution of grafts across a bulk sample in the range of from 0.02 to 1.0.

2. A composition according to claim 1, wherein said degree of polymerisation is between 25 and 250 and the degree of substitution of grafts across the bulk sample is in the range of from 0.02 to 0.2.

3. A composition according to claim 1, wherein the grafts on the polysaccharide backbone have a degree of polymerisation of between 50 and 100.

4. A composition according to claim 1, wherein said degree of polymerisation is between 5 and 50 and the degree of substitution of grafts across the bulk sample is in the range of from 0.1 to 1.0

5. A composition according to claim 1, wherein the number of grafts ranges from about 3 to 12 per polysaccharide backbone.

6. A composition according to claim 1, wherein said graft chains are homopolymers.

7. A composition according to claim 1, wherein said graft chains are copolymers.

8. A composition according to claim 1, wherein said polysaccharide backbone is cellulose, a cellulose derivative, a xyloglucan, a glucomannan, a galactomannan, chitosan or a chitosan salt.

9. A composition according to claim 1, wherein said polysaccharide backbone has a number average molecular weight from about 10,000 to about 40,000.

10. A composition according to claim 1, wherein said polymer is water soluble at a concentration of at least about 0.2 mg/mL.

11. A composition according to claim 1, wherein the polymer comprises a polysaccharide backbone and at least one pendant polymeric chain attached to said polysaccharide backbone, wherein said at least one chain comprises a control agent moiety that is selected from the group consisting of 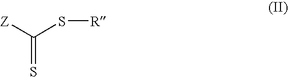
where Z is selected from the group consisting of optionally substituted alkyl, alkenyl, alkynyl, aralkyl, alkaryl, heteroalkyl, heteroalkenyl, heteroalkynyl, alkoxy, aryl, heteroaryl, amino; R″ is selected from the group consisting of optionally substituted hydrocarbyl and heteroatom-containing hydrocarbyl, and the group is attached to a linker or sugar unit via either the Z or R″ groups; and
—O—NR⁵R⁶
wherein each of R⁵ and R⁶ is independently selected from the group consisting of hydrocarbyl, substituted hydrocarbyl, heteroatom containing hydrocarbyl and substituted heteroatom containing hydrocarbyl; and optionally R⁵ and R⁶ are joined together in a ring structure.

12. A composition according to claim 11, wherein on average there are between 0.5 and 25 pendant polymeric chains attached to said polysaccharide backbone.

13. A composition according to claim 1, wherein said grafts have a number average molecular weight of from 100 to 10,000,000 Da.

14. A composition according to claim 1, wherein said polysaccharide backbone has a number average molecular weight of from about 3,000 to about 100,000.

15. A composition according to claim 11, wherein said pendant polymeric chains are attached to said polysaccharide backbone at a site selected from the group consisting of a terminus of said polysaccharide backbone and a mid-point of said polysaccharide backbone and combinations thereof.

16. A composition according to claim 1, wherein the polymer has the general formula I: 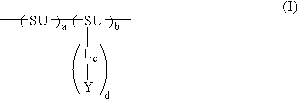
wherein SU represents a sugar unit in a polysaccharide, preferably cellulosic backbone, L is an optional linker, Y is a control agent moiety as defined in claim 11, a is in the range of from 3-80, b is in the range of from about 1-25, c is 0 or 1, and d is 1-3.

17. A composition according to claim 16, wherein c is 1 and said linker L comprises 2 to 50 non-hydrogen, preferably carbon, atoms.

18. A composition according to claim 17, wherein said linker is selected from the group consisting of di-isocyanates, methanes, and amides.

19. A composition according to claim 1 comprising from 0.01% to 25%, preferably from 0.05% to 15%, more preferably from 0.1 to 5% by weight of said polymer.

20. A composition according to claim 1, wherein the at least one additional ingredient is selected from surfactants, detergency builders, bleaches, transition metal sequestrants, enzymes, fabric softening and/or conditioning agents, lubricants for inhibition of fibre damage and/or for colour care and/or for crease reduction and/or for ease of ironing, UV absorbers such as fluorescers and photofading inhibitors, for example sunscreens/UV inhibitors and/or anti-oxidants, fungicides, insect repellents and/or insecticides, perfumes, dye fixatives, waterproofing agents, deposition aids, flocculants, anti-redeposition agents and soil release agents.

21. A method of delivering one or more laundry benefits in the cleaning of a textile fabric, the method comprising contacting the fabric with a polymer as defined in claim 1, preferably in the form of a laundry cleaning composition comprising said polymer, and most preferably in the form of an aqueous dispersion or solution of said composition.
